(19) United States
(12) Patent Application Publication
(10) Pub. No.: US 2024/0002650 A1
(43) Pub. Date: Jan. 4, 2024

(54) POLYMER COMPOSITIONS, RELATED METHODS, AND RELATED PRODUCTS

(71) Applicant: OMYA INTERNATIONAL AG, Oftringen (CH)

(72) Inventors: Anthony DYMEK, Harleysville, PA (US); Mannie Lee CLAPP, Cincinnati, OH (US)

(73) Assignee: OMYA INTERNATIONAL AG, Oftringen (CH)

(21) Appl. No.: 18/252,548

(22) PCT Filed: Nov. 29, 2021
(86) PCT No.: PCT/EP2021/083397

§ 371 Date: May 11, 2023

Related U.S. Application Data
(60) Provisional application No. 63/119,367, filed on Nov. 30, 2020.

(51) Int. Cl. C08L 27/06; C08J 3/22

(52) U.S. Cl. CPC C08L 27/06; C08J 3/226; C08L 2310/00; C08J 2423/06; C08L 2203/14; C08J 2327/06; C08L 2203/18

(57) ABSTRACT

Some embodiments of the invention include polymer compositions. In other embodiments, the polymer compositions Ncomprise a polymer resin composition and a masterbatch composition. Some embodiments of the invention include methods for decreasing fusion time. Further embodiments include methods for making polymer products from the polymer composition. Certain embodiments include the polymer products made from the polymer composition and/or the methods disclosed herein. Additional embodiments of the invention are also discussed herein.

### BACKGROUND

Some polymer products (e.g., rigid polymer products) are used for a great variety of applications, such as industrial applications, building applications, or consumer applications. In some instances, addition of calcium carbonate can reduce costs of the polymer products. In certain instances, addition of calcium carbonate (e.g., via a masterbatch) to some substrate materials (e.g., comprising a polymer resin) can result in differing process parameters, such as fusion time. This can sometimes impact the production of such polymer products.

Certain embodiments of the invention address one or more of the issues described above. For example, some embodiments of the invention include polymer compositions. In other embodiments, the polymer compositions comprise a polymer resin composition and a masterbatch composition. Further embodiments include methods for making polymer products from the polymer composition. Certain embodiments include the polymer products made from the polymer composition and/or the methods disclosed herein. Additional embodiments of the invention are also discussed herein.

### SUMMARY

Some embodiments of the present invention include a polymer composition comprising a) a polymer resin composition comprising at least one halogenated polymer resin and a first calcium carbonate material, and b) a masterbatch composition comprising (i) a second calcium carbonate material and (ii) at least one masterbatch polyethylene, at least one masterbatch polypropylene, or both. In certain embodiments, the at least one halogenated polymer resin is at least 50 wt % of the polymer composition, the first calcium carbonate material is no more than 34 wt % of the polymer composition, the second calcium carbonate material is from 1 to 35 wt % of the polymer composition, and the total calcium carbonate material in the polymer composition is from 17 to 35 wt % of the polymer composition. In other embodiments, the fusion time of the polymer composition is less than (A) the fusion time of a composition consisting of (1) the polymer resin composition and (2) the second calcium carbonate material, or (B) the fusion time of the polymer resin composition, where the fusion time is measured according to ASTM D2538-18. In still other embodiments, the calcium carbonate of the first calcium carbonate material, the second calcium carbonate material, or both, has a weight median particle diameter d₅₀ of from 0.4 μm to 1 μm, preferably from 0.5 μm to 0.9 μm, more preferably from 0.6 μm to 0.8 μm and most preferably of 0.7 μm, measured according to the sedimentation method. In yet other embodiments, the calcium carbonate of the first calcium carbonate material, of the second calcium carbonate material, or both, has a weight median particle diameter d₅₀ of from 0.1 μm to 8.0 μm, preferably from 0.1 μm to 4.0 μm, preferably from 0.5 μm to 2.3 μm, preferably from 1.1 μm to 1.7 μm, more preferably from 1.3 μm to 1.5 μm and most preferably of 1.4 μm, measured according to the sedimentation method. In certain embodiments, the calcium carbonate of the first calcium carbonate material, of the second calcium carbonate material, or both, has a specific surface area of from 1 m²/g to 25 m²/g, preferably from 5 m²/g to 15 m²/g and more preferably from 8 m²/g to 13 m²/g, measured using the BET nitrogen method. In some embodiments, the calcium carbonate of the first calcium carbonate material, of the second calcium carbonate material, or both, has a specific surface area of from 1 m²/g to 25 m²/g, preferably from 2 m²/g to 15 m²/g and more preferably from 3 m²/g to 10 m²/g, measured using the BET nitrogen method. In certain embodiments, the calcium carbonate of the first calcium carbonate material, of the second calcium carbonate material, or both, has a top cut d₉₈ of no more than 25 μm, preferably no more than 15 μm, more preferably no more than 10 μm, even more preferably no more than 8 μm, still more preferably no more than 6 μm, and most preferably no more than 4 μm. In other embodiments, the calcium carbonate of the first calcium carbonate material, of the second calcium carbonate material, or both, is ground calcium carbonate (GCC) and/or precipitated calcium carbonate (PCC), preferably ground calcium carbonate. In still other embodiments, at least 0.1%, preferably from 0.1% to 3%, and most preferably approximately 1%, of the aliphatic carboxylic acid accessible surface area of the calcium carbonate of the first calcium carbonate material, of the second calcium carbonate material, or both, is covered by a coating comprising at least one aliphatic carboxylic acid having from 4 to 24 carbon atoms and/or reaction products thereof, preferably by a coating comprising stearic acid and/or reaction products thereof. In yet other embodiments, at least 0.1%, preferably from 0.1% to 3%, and most preferably approximately 1%, of the accessible surface area of the calcium carbonate of the first calcium carbonate material, of the second calcium carbonate material, or both, is covered by a coating comprising at least one mono-substituted succinic anhydride, at least one mono-substituted succinic acid, at least one reaction product of mono-substituted succinic anhydride and/or at least one reaction product of mono-substituted succinic acid, preferably by a coating comprising at least one mono-substituted succinic anhydride consisting of succinic anhydride mono-substituted with a group selected from a linear, branched, aliphatic and cyclic group having a total amount of carbon atoms from C2 to C30 in the substituent and/or reaction products thereof. In certain embodiments, the first calcium carbonate material is present in an amount from 1 to 25 wt % of the polymer composition, preferably from 5 to 20 wt % of the polymer composition, more preferably from 10 to 16 wt % of the polymer composition, and most preferably from 12 to 16 wt % of the polymer composition. In other embodiments, the second calcium carbonate material is present in an amount from 1 to 25 wt % of the polymer composition, preferably from 3 to 15 wt % of the polymer composition, more preferably from 4 to 10 wt % of the polymer composition, and most preferably from 5 to 9 wt % of the polymer composition. In some embodiments, the total calcium carbonate material in the polymer composition is from 17 to 30 wt % of the polymer composition, preferably from 17 to 27 wt % of the polymer composition, more preferably from 18 to 25 wt % of the polymer composition, and most preferably from 19 to 23 wt % of the polymer composition.

In some embodiments, the at least one masterbatch polyethylene, at least one masterbatch polypropylene, or both are present in an amount from 0.1 to 5.0 wt % of the polymer composition, preferably from 0.2 to 3.0 wt % of the polymer composition, more preferably from 0.5 to 2.0 wt % of the polymer composition, and most preferably from 0.8 to 1.3 wt % of the polymer composition. In other embodiments, the at least one masterbatch polyethylene has a density from to 0.975 g/cm³, preferably from 0.890 to 0.970 g/cm³, more preferably from 0.895 to 0.970 g/cm³, even more preferably from 0.900 to 0.965 g/cm³, still more preferably from 0.905 to 0.960 g/cm³, and most preferably from 0.920 to 0.960 g/cm³. In yet other embodiments, the at least one masterbatch polyethylene is a high density polyethylene, low density polyethylene, or a linear low density polyethylene. In still other embodiments, the at least one masterbatch polypropylene is a polypropylene homopolymer.

In some embodiments, the masterbatch composition does not include a halogenated polymer resin. In other embodiments, the masterbatch composition does not include PVC, post-chlorinated vinyl polychloride (PVCC), or polyvinylidene fluoride (PVDF). In still other embodiments, the masterbatch composition consists of (i) the second calcium carbonate material and (ii) at least one masterbatch polyethylene, at least one masterbatch polypropylene, or both.

In some embodiments, the at least one halogenated polymer resin is selected from the group consisting of PVC, post-chlorinated vinyl polychloride (PVCC), polyvinylidene fluoride (PVDF), and mixtures thereof, preferably PVC. In certain embodiments, the at least one halogenated polymer resin is PVC and the PVC has a K-value of from 50 to 100, preferably from 50 to 80, more preferably from 55 to 75, and most preferably from 55 to 70. In other embodiments, the at least one halogenated polymer resin is in an amount of from 50 to 90 wt % of the polymer composition, preferably from 55 to 85 wt % of the polymer composition, more preferably from 60 to 85 wt % of the polymer composition, and most preferably from 65 to 80 wt % of the polymer composition.

In some embodiments, the fusion time of the polymer composition is less than (A) the fusion time of a composition consisting of (1) the polymer resin composition and (2) the second calcium carbonate material or (B) the fusion time of the polymer resin composition, where the difference in fusion time is at least 1 second, preferably at least 50 seconds, more preferably at least 100 seconds, and most preferably at least 150 seconds. In other embodiments, the fusion time of the polymer composition is less than (A) the fusion time of a composition consisting of (1) the polymer resin composition and (2) the second calcium carbonate material or (B) the fusion time of the polymer resin composition, where the difference in fusion time is from 1 to 1500 seconds, preferably from 50 to 1500 seconds, more preferably from 100 to 1500 seconds, and most preferably from 150 to 1500 seconds. In certain embodiments, the fusion time of the polymer composition is less than the fusion time of a composition consisting of (1) the polymer resin composition and (2) the second calcium carbonate material.

In some embodiments, the polymer composition further comprises at least one of blowing agents, processing aids, impact modifiers, stabilizers, nucleating agents, lubricants, waxes, pigments, colouring agents, plasticizers, thermal modifiers, flame retardants, biocides, smoke suppressors, UV Inhibitors, and mixtures thereof.

In other embodiments, the polymer composition is suitable to make a polymer product which has a density of below 1 g/cm³, preferably of below 0.80 g/cm³, more preferably of below 0.75 g/cm³ and most preferably of below 0.73 g/cm³, for example from 0.5 to 0.80 g/cm³ or 0.71 g/cm³. In certain embodiments, the polymer composition is suitable to make a polymer product which has an impact strength from 30 to 150 inch lbs, preferably from 40 to 100 inch lbs, and most preferably from to 80 inch lbs, measured according to ASTM D4226. In yet other embodiments, the polymer composition is suitable to make a polymer product which has a Durometer Hardness of (a) at least 50 A, preferably from 60 A to 100 A, more preferably from 80 A to 100 A, and most preferably from 90 A to 100 A, measured using ASTM D2240 with an A scale Durometer or (b) at least 20 D, preferably at least 50 D, more preferably from 40 D to 100 D, and most preferably from 70 D to 100 D, measured using ASTM D2240 with a D scale Durometer.

Some embodiments of the invention include a method for decreasing fusion time, comprising a) providing a polymer resin composition comprising at least one halogenated polymer resin and a first calcium carbonate material, b) providing a masterbatch composition comprising (i) a second calcium carbonate material and (ii) at least one masterbatch polyethylene, at least one masterbatch polypropylene, or both, and c) contacting the polymer resin composition with the masterbatch composition to provide a polymer composition. In other embodiments, the at least one halogenated polymer resin is at least 50 wt % of the polymer composition. In still other embodiments, the first calcium carbonate material is no more than 34 wt % of the polymer composition. In yet other embodiments, the second calcium carbonate material is from 1 to 35 wt % of the polymer composition. In certain embodiments, the total calcium carbonate material in the polymer composition is from 17 to wt % of the polymer composition. In some embodiments, the fusion time of the polymer composition is less than (A) the fusion time of a composition consisting of (1) the polymer resin composition and (2) the second calcium carbonate material, or (B) the fusion time of the polymer resin composition, where the fusion time is measured according to ASTM D2538-18.

In still other embodiments of the method, the calcium carbonate of the first calcium carbonate material, the second calcium carbonate material, or both, has a weight median particle diameter d₅₀ of from 0.4 μm to 1 μm, preferably from 0.5 μm to 0.9 μm, more preferably from 0.6 μm to 0.8 μm and most preferably of 0.7 μm, measured according to the sedimentation method. In yet other embodiments, the calcium carbonate of the first calcium carbonate material, of the second calcium carbonate material, or both, has a weight median particle diameter d₅₀ of from 0.1 μm to 8.0 μm, preferably from 0.1 μm to 4.0 μm, preferably from 0.5 μm to 2.3 μm, preferably from 1.1 μm to 1.7 μm, more preferably from 1.3 μm to 1.5 μm and most preferably of 1.4 μm, measured according to the sedimentation method. In certain embodiments, the calcium carbonate of the first calcium carbonate material, of the second calcium carbonate material, or both, has a specific surface area of from 1 m²/g to 25 m²/g, preferably from 5 m²/g to 15 m²/g and more preferably from 8 m²/g to 13 m²/g, measured using the BET nitrogen method. In some embodiments, the calcium carbonate of the first calcium carbonate material, of the second calcium carbonate material, or both, has a specific surface area of from 1 m²/g to 25 m²/g, preferably from 2 m²/g to 15 m²/g and more preferably from 3 m²/g to 10 m²/g, measured using the BET nitrogen method. In certain embodiments, the calcium carbonate of the first calcium carbonate material, of the second calcium carbonate material, or both, has a top cut d₉₈ of no more than 25 μm, preferably no more than 15 μm, more preferably no more than 10 μm, even more preferably no more than 8 μm, still more preferably no more than 6 μm, and most preferably no more than 4 μm. In other embodiments, the calcium carbonate of the first calcium carbonate material, of the second calcium carbonate material, or both, is ground calcium carbonate (GCC) and/or precipitated calcium carbonate (PCC), preferably ground calcium carbonate. In still other embodiments, at least preferably from 0.1% to 3%, and most preferably approximately 1%, of the aliphatic carboxylic acid accessible surface area of the calcium carbonate of the first calcium carbonate material, of the second calcium carbonate material, or both, is covered by a coating comprising at least one aliphatic carboxylic acid having from 4 to 24 carbon atoms and/or reaction products thereof, preferably by a coating comprising stearic acid and/or reaction products thereof. In yet other embodiments, at least preferably from 0.1% to 3%, and most preferably approximately 1%, of the accessible surface area of the calcium carbonate of the first calcium carbonate material, of the second calcium carbonate material, or both, is covered by a coating comprising at least one mono-substituted succinic anhydride, at least one mono-substituted succinic acid, at least one reaction product of mono-substituted succinic anhydride and/or at least one reaction product of mono-substituted succinic acid, preferably by a coating comprising at least one mono-substituted succinic anhydride consisting of succinic anhydride mono-substituted with a group selected from a linear, branched, aliphatic and cyclic group having a total amount of carbon atoms from C2 to C30 in the substituent and/or reaction products thereof. In certain embodiments, the first calcium carbonate material is present in an amount from 1 to 25 wt % of the polymer composition, preferably from 5 to 20 wt % of the polymer composition, more preferably from 10 to 16 wt % of the polymer composition, and most preferably from 12 to 16 wt % of the polymer composition. In other embodiments, the second calcium carbonate material is present in an amount from 1 to 25 wt % of the polymer composition, preferably from 3 to 15 wt % of the polymer composition, more preferably from 4 to 10 wt % of the polymer composition, and most preferably from 5 to 9 wt % of the polymer composition. In some embodiments, the total calcium carbonate material in the polymer composition is from 17 to 30 wt % of the polymer composition, preferably from 17 to 27 wt % of the polymer composition, more preferably from 18 to 25 wt % of the polymer composition, and most preferably from 19 to 23 wt % of the polymer composition.

In some embodiments of the method, the at least one masterbatch polyethylene, at least one masterbatch polypropylene, or both are present in an amount from 0.1 to 5.0 wt % of the polymer composition, preferably from 0.2 to 3.0 wt % of the polymer composition, more preferably from to 2.0 wt % of the polymer composition, and most preferably from 0.8 to 1.3 wt % of the polymer composition. In other embodiments, the at least one masterbatch polyethylene has a density from 0.850 to 0.975 g/cm³, preferably from 0.890 to 0.970 g/cm³, more preferably from 0.895 to 0.970 g/cm³, even more preferably from 0.900 to 0.965 g/cm³, still more preferably from 0.905 to 0.960 g/cm³, and most preferably from 0.920 to 0.960 g/cm³. In yet other embodiments, the at least one masterbatch polyethylene is a high density polyethylene, low density polyethylene, or a linear low density polyethylene. In still other embodiments, the at least one masterbatch polypropylene is a polypropylene homopolymer.

In some embodiments of the method, the masterbatch composition does not include a halogenated polymer resin. In other embodiments, the masterbatch composition does not include PVC, post-chlorinated vinyl polychloride (PVCC), or polyvinylidene fluoride (PVDF). In still other embodiments, the masterbatch composition consists of (i) the second calcium carbonate material and (ii) at least one masterbatch polyethylene, at least one masterbatch polypropylene, or both.

In some embodiments of the method, the at least one halogenated polymer resin is selected from the group consisting of PVC, post-chlorinated vinyl polychloride (PVCC), polyvinylidene fluoride (PVDF), and mixtures thereof, preferably PVC. In certain embodiments, the at least one halogenated polymer resin is PVC and the PVC has a K-value of from 50 to 100, preferably from 50 to 80, more preferably from 55 to 75, and most preferably from 55 to 70. In other embodiments, the at least one halogenated polymer resin is in an amount of from 50 to 90 wt % of the polymer composition, preferably from 55 to 85 wt % of the polymer composition, more preferably from 60 to 85 wt % of the polymer composition, and most preferably from 65 to 80 wt % of the polymer composition.

In some embodiments of the method, the fusion time of the polymer composition is less than (A) the fusion time of a composition consisting of (1) the polymer resin composition and (2) the second calcium carbonate material or (B) the fusion time of the polymer resin composition, where the difference in fusion time is at least 1 second, preferably at least 50 seconds, more preferably at least 100 seconds, and most preferably at least 150 seconds. In other embodiments, the fusion time of the polymer composition is less than (A) the fusion time of a composition consisting of (1) the polymer resin composition and (2) the second calcium carbonate material or (B) the fusion time of the polymer resin composition, where the difference in fusion time is from 1 to 1500 seconds, preferably from 50 to 1500 seconds, more preferably from 100 to 1500 seconds, and most preferably from 150 to 1500 seconds. In certain embodiments, the fusion time of the polymer composition is less than the fusion time of a composition consisting of (1) the polymer resin composition and (2) the second calcium carbonate material.

In some embodiments of the method, the polymer composition further comprises at least one of blowing agents, processing aids, impact modifiers, stabilizers, nucleating agents, lubricants, waxes, pigments, colouring agents, plasticizers, thermal modifiers, flame retardants, biocides, smoke suppressors, UV Inhibitors, and mixtures thereof.

In other embodiments of the method, the polymer composition is suitable to make a polymer product which has a density of below 1 g/cm³, preferably of below 0.80 g/cm³, more preferably of below 0.75 g/cm³ and most preferably of below 0.73 g/cm³, for example from 0.5 to 0.80 g/cm³ or 0.71 g/cm³. In certain embodiments, the polymer composition is suitable to make a polymer product which has an impact strength from 30 to 150 inch lbs, preferably from 40 to 100 inch lbs, and most preferably from 50 to 80 inch lbs, measured according to ASTM D4226. In yet other embodiments, the polymer composition is suitable to make a polymer product which has a Durometer Hardness of (a) at least 50 A, preferably from 60 A to 100 A, more preferably from 80 A to 100 A, and most preferably from 90 A to 100 A, measured using ASTM D2240 with an A scale Durometer or (b) at least 20 D, preferably at least 50 D, more preferably from 40 D to 100 D, and most preferably from 70 D to 100 D, measured using ASTM D2240 with a D scale Durometer.

Some embodiments of the invention include a method for preparing a polymer product comprising the following steps: (a) providing the polymer composition according to any suitable polymer composition including those disclosed herein, and (b) subjecting the polymer composition of step (a) to conditions under which the polymer composition is converted into a polymer product. In certain embodiments, the polymer product has a density of below 1 g/cm³, preferably of below 0.80 g/cm³, more preferably of below 0.75 g/cm³ and most preferably of below 0.73 g/cm³, for example from to 0.80 g/cm³ or 0.71 g/cm³. In other embodiments, the polymer product has an impact strength from 30 to 150 inch lbs, preferably from 40 to 100 inch lbs, and most preferably from 50 to 80 inch lbs, measured according to ASTM D4226. In still other embodiments, the polymer product has a Durometer Hardness of (a) at least 50 A, preferably from 60 A to 100 A, more preferably from 80 A to 100 A, and most preferably from 90 A to 100 A, measured using ASTM D2240 with an A scale Durometer or (b) at least 20 D, preferably at least 50 D, more preferably from 40 D to 100 D, and most preferably from 70 D to 100 D, measured using ASTM D2240 with a D scale Durometer.

Some embodiments of the invention include a polymer product prepared according to any suitable method including those disclosed herein. Other embodiments include a polymer product prepared from the polymer composition according to any suitable polymer composition including those disclosed herein. In certain embodiments, the polymer product is a pipe, tubing, siding, window profile, roller-blind profile, sheet, sign, tile, fencing, decking, gutters, credit card stock, blister pack, UL conduit, foam board, foam trim, ceiling tile, and vinyl record.

Some embodiments include uses of the polymer composition according to any suitable polymer composition including those disclosed herein.

Other embodiments of the invention are also discussed herein.

### BRIEF DESCRIPTION OF THE DRAWINGS

The following drawings form part of the present specification and are included to further demonstrate certain aspects of the present invention. The invention may be better understood by reference to one or more of these drawings in combination with the description of specific embodiments presented herein.

FIG. 1: MELT RHEOLOGY—BRABENDER 100 cc@40 RPM@180° C.

FIG. 2: MELT RHEOLOGY—BRABENDER 100 cc@80 RPM@180° C.

FIG. 3: FUSION TIME—BRABENDER@ 180° C.@ 40 RPM.

FIG. 4: FUSION TIME—BRABENDER@ 180° C.@ 80 RPM.

FIG. 5: CONTROL SAMPLE—BRABENDER@ 180° C.@ 40 RPM.

FIG. 6: SAMPLE B1—BRABENDER@ 180° C.@ 40 RPM.

FIG. 7: SAMPLE B2—BRABENDER@ 180° C.@ 40 RPM.

FIG. 8: SAMPLE B4—BRABENDER@ 180° C.@ 40 RPM.

FIG. 9: SAMPLE B7—BRABENDER@ 180° C.@ 40 RPM.

FIG. 10: CONTROL SAMPLE—BRABENDER@ 180° C.@ 80 RPM.

FIG. 11: SAMPLE B1—BRABENDER@ 180° C.@ 80 RPM.

FIG. 12: SAMPLE B2—BRABENDER@ 180° C.@ 80 RPM.

FIG. 13: SAMPLE B4—BRABENDER@ 180° C.@ 80 RPM.

FIG. 14: SAMPLE B7- BRABENDER @ 180° C.@ 80 RPM.

### DETAILED DESCRIPTION

While embodiments encompassing the general inventive concepts may take diverse forms, various embodiments will be described herein, with the understanding that the present disclosure is to be considered merely exemplary, and the general inventive concepts are not intended to be limited to the disclosed embodiments.

It should be understood that for the purposes of the present invention, the following terms have the following meaning:

The term “surface-treated” calcium carbonate in the meaning of the present invention refers to a material comprising calcium carbonate covered by a coating consisting of the agent used for the surface treatment and reaction products thereof.

As used herein and as generally defined in the art, the weight median particle diameter “d₅₀” value is defined as the size at which 50% (the mean point) of the particle volume or mass is accounted for by particles having a diameter equal to the specified value. Unless otherwise stated, the weight median particle diameter is measured before any surface treatment (e.g., stearic acid surface treatment) of the particle. The weight median particle diameter was measured according to the sedimentation method. The sedimentation method is an analysis of sedimentation behavior in a gravimetric field. The measurement is made with a Sedigraph™ 5100 of Micromeritics Instrument

Corporation.

As used herein and as generally defined in the art, the diameter “d₉₈” value (also referred to as “top cut” or “top size”) is defined as the size where at least 98% of the particle volume or mass have a diameter less than the specified value. Unless otherwise stated, the d₉₈ is measured before any surface treatment (e.g., stearic acid surface treatment) of the particle. The d₉₈ was measured according to the sedimentation method. The sedimentation method is an analysis of sedimentation behavior in a gravimetric field. The measurement is made with a Sedigraph™ 5100 of Micromeritics Instrument Corporation.

The term “phr” in the meaning of the present invention means “parts per hundred resins”. In particular, if 100 parts of polymer resin are used, the quantity of other ingredients is expressed in relation to this 100 parts of polymer resin.

In some embodiments of the invention, polymer compositions are disclosed. In other embodiments, the polymer compositions comprise a polymer resin composition and a masterbatch composition. Further embodiments include methods for making polymer products from the polymer composition. Certain embodiments include the polymer products made from the polymer composition and/or the methods disclosed herein. Additional embodiments of the invention are also discussed herein.

### Polymer Compositions

Certain embodiments of the invention include polymer compositions comprising (a) a

polymer resin composition comprising at least one halogenated polymer resin and a first calcium carbonate material; and (b) a masterbatch composition comprising (i) a second calcium carbonate material and (ii) at least one masterbatch polyethylene, at least one masterbatch polypropylene, or both. In some embodiments, the polymer composition is a solid, a liquid, or a mixture

thereof. In other embodiments, the amount of polymer resin composition in the polymer composition is from 80 wt % to 99 wt %, from 85 wt % to 95 wt %, or from 89 wt % to 93 wt % of the polymer composition. In still other embodiments, the amount of the masterbatch composition in the polymer composition is from 1 wt % to 20 wt %, from 5 wt % to 15 wt %, or from 7 wt % to 11 wt % of the polymer composition.

In some embodiments, the at least one halogenated polymer resin can comprise any suitable halogenated polymer resin including but not limited to those described herein. In other embodiments, the at least one halogenated polymer resin can be at least 50 wt %, at least 51 wt %, at least 52 wt %, at least 53 wt %, at least 54 wt %, at least 55 wt %, at least 56 wt %, at least 58 wt %, at least 60 wt %, at least 65 wt %, at least 70 wt %, at least 75 wt %, at least 80 wt %, at least 83 wt %, at least 85 wt %, or at least 90 wt % of the polymer composition. In certain embodiments, the at least one halogenated polymer resin can be from 50 wt % to 90 wt %, from 50 wt % to 83 wt %, from 50 wt % to 85 wt %, from 50 wt % to 80 wt %, from 55 wt % to 90 wt %, from 55 wt % to 85 wt %, from 55 wt % to 80 wt %, from 60 wt % to 90 wt %, or from 60 wt % to 80 wt % from 65 wt % to 90 wt %, or from 65 wt % to 80 wt % of the polymer composition.

In still other embodiments, the first calcium carbonate material can be any suitable calcium carbonate material including but not limited to those described herein. In other embodiments, the first calcium carbonate material can be no more than 34 wt %, no more than 33 wt %, no more than 32 wt %, no more than 31 wt %, no more than 30 wt %, no more than 28 wt %, no more than 25 wt %, no more than 23 wt %, no more than 20 wt %, no more than 19 wt %, no more than 18 wt %, no more than 17 wt'Yo, no more than 16 wt'Yo, no more than 15 wt'Yo, no more than 14 wt'Yo, no more than 13 wt'Yo, or no more than 10 wt % of the polymer composition. In certain embodiments, the first calcium carbonate material can be 1 wt %, 2 wt'Yo, 3 wt'Yo, 4 wt'Yo, 5 wt'Yo, 6 wt'Yo, 7 wt'Yo, 8 wt'Yo, 9 wt'Yo, 10 wt'Yo, 11 wt %, 12 wt'Yo, 13 wt'Yo, 14 wt'Yo, 15 wt'Yo, 16 wt'Yo, 17 wt'Yo, 18 wt'Yo, 19 wt'Yo, 20 wt'Yo, 21 wt'Yo, 22 wt'Yo, 23 wt %, 24 wt %, 25 wt %, 26 wt %, 27 wt %, 28 wt %, 29 wt %, 30 wt %, 31 wt %, 32 wt %, 33 wt %, or 34 wt % of the polymer composition. In certain embodiments, the first calcium carbonate material can be from wt % to 34 wt %, from 11 wt % to 34 wt %, from 12 wt % to 34 wt %, from 13 wt % to 34 wt %, from 14 wt % to 34 wt %, from 15 wt % to 34 wt %, from 10 wt % to 30 wt %, from 11 wt % to 30 wt %, from 12 wt % to 30 wt %, from 13 wt % to 30 wt %, from 14 wt % to 30 wt %, from 15 wt % to 30 wt %, from 10 wt % to 25 wt %, from 11 wt % to 25 wt %, from 12 wt % to 25 wt %, from 13 wt % to 25 wt %, from 14 wt % to 25 wt %, from 15 wt % to 25 wt %, from 10 wt % to 20 wt %, from 11 wt % to 20 wt %, from 12 wt % to 20 wt %, from 13 wt % to 20 wt %, from 14 wt % to 20 wt %, or from 15 wt % to 20 wt % of the polymer composition.

In yet other embodiments, the second calcium carbonate material can be any suitable calcium carbonate material including but not limited to those described herein. In other embodiments, the second calcium carbonate material, the second calcium carbonate material can be 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, or 35 wt % of the polymer composition. In certain embodiments, the second calcium carbonate material can be from 1 to 35 wt %, from 2 to 35 wt %, from 3 to 35 wt %, from 4 to 35 wt %, from 5 to 35 wt %, from 10 to 35 wt %, from to 35 wt %, from 17 to 35 wt %, from 18 to 35 wt %, from 19 to 35 wt %, from 20 to 35 wt %, from 25 to wt %, from 1 to 30 wt %, from 2 to 30 wt %, from 3 to 30 wt %, from 4 to 30 wt %, from 5 to 30 wt %, from 10 to 30 wt %, from 15 to 30 wt %, from 17 to 30 wt %, from 18 to 30 wt %, from 19 to 30 wt %, from to 30 wt %, from 25 to 30 wt %, from 1 to 25 wt %, from 2 to 25 wt %, from 3 to 25 wt %, from 4 to 25 wt %, from 5 to 25 wt %, from 10 to 25 wt %, from 15 to 25 wt %, from 17 to 25 wt %, from 18 to 25 wt %, from 19 to 25 wt %, or from 20 to 25 wt % of the polymer composition.

In other embodiments, the total calcium carbonate material in the polymer composition can be 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, or 35 wt % of the polymer composition. In certain embodiments, the total calcium carbonate material in the polymer composition can be from 17 to 35 wt %, from 18 to 35 wt %, from 19 to 35 wt %, from 20 to 35 wt %, from 25 to 35 wt %, from 17 to 30 wt %, from 18 to 30 wt %, from 19 to 30 wt %, from 20 to 30 wt %, from 17 to 25 wt %, from 18 to 25 wt %, from 19 to 25 wt %, or from 20 to 25 wt % of the polymer composition.

In yet other embodiments, the at least one masterbatch polyethylene can comprise any suitable polyethylene including but not limited to those described herein. In certain embodiments, the at least one masterbatch polyethylene can be 0.01 wt %, 0.05 wt %, 0.1 wt %, 0.15 wt %, 0.2 wt %, wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt'Yo, 4.5 wt %, 5.0 wt %, 5.5 wt %, or 6.0 wt'Yo of the polymer composition. In other embodiments, the at least one masterbatch polyethylene can be from 0.01 wt % to 6.0 wt %, from 0.1 wt % to 3.0 wt %, from 0.2 wt % to 2.0 wt %, or from 0.5 wt % to 1.7 wt % of the polymer composition.

In yet other embodiments, the at least one masterbatch polypropylene can comprise any suitable polypropylene including but not limited to those described herein. In certain embodiments, the at least one masterbatch polypropylene can be 0.01 wt %, 0.05 wt %, 0.1 wt %, 0.15 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.5 wt %, 5.0 wt %, 5.5 wt %, or 6.0 wt % of the polymer composition. In other embodiments, the at least one masterbatch polypropylene can be from 0.01 wt % to 6.0 wt %, from 0.1 wt % to 3.0 wt %, from 0.2 wt % to 2.0 wt %, or from 0.5 wt % to 1.7 wt % of the polymer composition.

In some embodiments, the fusion time (e.g., the fusion time is measured according to ASTM D2538-18) of the polymer composition is less than (A) the fusion time of a composition consisting of (1) the polymer resin composition and (2) the second calcium carbonate material or (B) the fusion time of the polymer resin composition; in certain embodiments, the difference in fusion time is 1 second, 2 seconds, 3 seconds, 4 seconds, 5 seconds, 6 seconds, 7 seconds, 8 seconds, 9 seconds, 10 seconds, 15 seconds, 20 seconds, 30 seconds, 40 seconds, 50 seconds, 60 seconds, 70 seconds, 80 seconds, 90 seconds, 100 seconds, 125 seconds, 150 seconds, 200 seconds, 300 seconds, 400 seconds, 500 seconds, 600 seconds, 700 seconds, 800 seconds, 900 seconds, 1000 seconds, 1250 seconds, 1500 seconds, at least 1 second, at least 50 seconds, at least 100 seconds, or at least 150 seconds. In other embodiments, the fusion time of the polymer composition is less than (A) the fusion time of a composition consisting of (1) the polymer resin composition and (2) the second calcium carbonate material or (B) the fusion time of the polymer resin composition, where the difference in fusion time is from 1 to 1500 seconds, from 50 to 1500 seconds, from 100 to 1500 seconds, or from 150 to 1500 seconds.

In some embodiments, the fusion time (e.g., the fusion time is measured according to ASTM D2538-18) of the polymer composition is less than the fusion time of a composition consisting of (1) the polymer resin composition and (2) the second calcium carbonate material; in certain embodiments, the difference in fusion time is 1 second, 2 seconds, 3 seconds, 4 seconds, 5 seconds, 6 seconds, 7 seconds, 8 seconds, 9 seconds, 10 seconds, 15 seconds, 20 seconds, 30 seconds, 40 seconds, 50 seconds, 60 seconds, 70 seconds, 80 seconds, 90 seconds, 100 seconds, 125 seconds, 150 seconds, 200 seconds, 300 seconds, 400 seconds, 500 seconds, 600 seconds, 700 seconds, 800 seconds, 900 seconds, 1000 seconds, 1250 seconds, 1500 seconds, at least 1 second, at least 50 seconds, at least 100 seconds, or at least 150 seconds. In other embodiments, the fusion time of the polymer composition is less than the fusion time of a composition consisting of (1) the polymer resin composition and (2) the second calcium carbonate material, where the difference in fusion time is from 1 to 1500 seconds, from 50 to 1500 seconds, from 100 to 1500 seconds, or from 150 to 1500 seconds.

In some embodiments, the polymer composition is suitable to be made into a polymer product with a Durometer Hardness of 20 A, 25 A, 30 A, 35 A, 40 A, 45 A, 50 A, 55 A, 60 A, 65 A, 70

A, 75 A, 80 A, 85 A, 90 A, 95 A, 100 A, 105 A, 110 A, 115 A, 120 A, 125 A, 130 A, 135 A, 140 A, 145 A, 150 A, 160 A, 170 A, 180 A, 190 A, 200 A, at least 20 A, at least 50 A, from 50 A to 100 A, from 60 A to 100 A, from 70 A to 100 A, from 80 A to 100 A, or from 90 A to 100 A, measured using ASTM D2240 with a A scale Durometer.

In some embodiments, the polymer composition is suitable to be made into a polymer product with a Durometer Hardness of 20 D, 25 D, 30 D, 35 D, 40 D, 45 D, 50 D, 55 D, 60 D, 65 D, 70 D, 75 D, 80 D, 85 D, 90 D, 95 D, 100 D, 105 D, 110 D, 115 D, 120 D, 125 D, 130 D, 135 D, 140 D, 145 D, 150 D, 160 D, 170 D, 180 D, 190 D, 200 D, at least 20 D, at least 30 D, at least 40 D, at least 50 D, from 20 D to 100 D, from 30 D to 100 D, from 40 D to 100 D, from 50 D to 100 D, from 60 D to 100 D, from 70 D to 100 D, from 80 D to 100 D, or from 90 D to 100 D, measured using ASTM D2240 with a

D scale Durometer.

In other embodiments, the polymer composition is suitable to be made into a polymer product with a density of below 1 g/cm³, below 0.80 g/cm³, below 0.75 g/cm³, below 0.73 g/cm³, for example from 0.55 to 0.80 g/cm³ or 0.71 g/cm³.

In other embodiments, the polymer composition is suitable to be made into a polymer product with an impact strength from 30 to 150 inch lbs, from 40 to 100 inch lbs, or from 50 to 80 inch lbs, measured according to ASTM D4226 on extruded samples.

In other embodiments, the polymer composition is suitable to be made into a polymer product that is a pipe, tubing, siding, window profile, roller-blind profile, sheet, sign, tile, fencing, decking, gutters, credit card stock, blister pack, UL conduit, foam board, foam trim, ceiling tile, and vinyl record.

### Halogenated Polymer Resin

The at least one halogenated polymer resin can comprise any suitable halogenated polymer resin, including but not limited to those described herein. In some embodiments, the at least one halogenated polymer resin can be PVC, post-chlorinated vinyl polychloride (PVCC), vinylidene polyfluoride (PVDF) and mixtures thereof.

In certain embodiments, the at least one halogenated polymer resin comprises PVC.

In other embodiments, the at least one halogenated polymer resin comprises a polyvinyl chloride resin which in certain instances can be processed into a PVC foam (e.g., rigid PVC foam). In some embodiments, the polyvinyl chloride resin comprises a polyvinyl chloride homopolymer or a copolymer of vinyl chloride with a copolymerizable ethylenically unsaturated monomer. In certain embodiments, where a homopolymer of polyvinyl chloride is used, the polyvinyl chloride resin contains monomers consisting of vinyl chloride alone. In certain embodiments, the polyvinyl chloride resin contains a mixture of monomers

comprising a predominant amount of monomers consisting of vinyl chloride. In other embodiments, the polyvinyl chloride resin can contain a mixture of monomers comprising an amount of monomers consisting of vinyl chloride of at least 60 wt %, of at least 70 wt % or of at least 80 wt %, based on the total weight of the monomer mixture. In still other embodiments, polyvinyl chloride copolymers can be composed of vinyl chloride and from 1 to 40 wt % of a copolymerizable ethylenically unsaturated monomer, at most of 30 wt % or at most of 20 wt % of a copolymerizable ethylenically unsaturated monomer, based on the total weight of the monomer mixture.

In some embodiments, the copolymerizable ethylenically unsaturated monomer is selected from the group consisting of vinylidene chloride, vinyl acetate, vinyl butyrate, vinyl benzoate, vinylidene chloride, diethyl fumarate, diethyl maleate, vinyl propionate, methyl acrylate, butyl acrylate, methyl methacrylate, ethyl methacrylate, butyl methacrylate, styrene, vinyl ethers such as vinyl ethyl ether, vinyl chloroethyl ether and vinyl phenyl ether, vinyl ketones such as vinyl methyl ketone and vinyl phenyl ketone, acrylonitrile, chloroacrylonitrile and mixtures thereof. In some embodiments, the polyvinyl chloride copolymers of the present invention comprise monomers of vinyl chloride and vinyl acetate, vinyl chloride and vinyl acetate and maleic anhydride or vinyl chloride and vinylidene chloride.

In certain embodiments, the polyvinyl chloride resin comprises a homopolymer of polyvinyl chloride.

Alternatively, the polyvinyl chloride resin comprises a mixture of a polyvinyl chloride homopolymer and a polyvinyl chloride copolymer comprising monomers of vinyl chloride and vinyl acetate, vinyl chloride and vinyl acetate and maleic anhydride or vinyl chloride and vinylidene chloride.

If the polyvinyl chloride resin comprises a mixture of a polyvinyl chloride homopolymer and a polyvinyl chloride copolymer, the mole ratio of the homopolymer and the copolymer is from 99:1 to 1:99, from 50:1 to 1:50, from 25:1 to 1:25, or from 10:1 to 1:10. In some embodiments of the present invention, the mole ratio of the homopolymer and the copolymer is from 90:1 to 1:1, from 90:1 to 10:1, or from 90:1 to 50:1. In certain embodiments, the mole ratio of the homopolymer and the copolymer is about 1:1.

Any suitable halogenated polymer resin can be used, including, for example, halogenated polymer resins that have a K-value from 50 to 100. The “K-value” is calculated from the inherent viscosity using DIN 53726. In some embodiments, the halogenated polymer resin has a K-value from 50 to 100, from 50 to 90, from 50 to 85, from 50 to 80, from 50 to 75, from 50 to 70, from 55 to 100, from 55 to 90, from 55 to 85, from 55 to 80, from 55 to 75, from 55 to 70, from 60 to 100, from to 90, from 60 to 85, from 60 to 80, from 60 to 75, from 60 to 70, or from 58 to 63. For example, the halogenated polymer resin has a K-value of about 65.

Any suitable homopolymer or copolymer of polyvinyl chloride can be used halogenated polymer resin, including, for example, polyvinyl chloride polymer resins that have a K-value from 50 to 100. In some embodiments, the polyvinyl chloride polymer resin has a K-value from to 100, from 50 to 90, from 50 to 85, from 50 to 80, from 50 to 75, from 50 to 70, from 55 to 100, from 55 to 90, from 55 to 85, from 55 to 80, from 55 to 75, from 55 to 70, from 60 to 100, from 60 to from 60 to 85, from 60 to 80, from 60 to 75, from 60 to 70, or from 58 to 63. For example, the polyvinyl chloride polymer resin has a K-value of about 65. Halogenated polymers resins (e.g., polyvinyl chloride polymer resins) suitable in the

inventive composition can be, but are not required to be, available from commercial sources. Some examples of halogenated polymer resins (e.g., polyvinyl chloride polymer resins) include resins available from INEOS Chlor Americas Inc., Wilmington, USA (e.g., Evipol SH6030 PVC) or resins available from Westlake Chemical Houston Tex., USA (e.g., PVC 1091).

In some embodiments, the at least one halogenated polymer resin (e.g., polyvinyl chloride polymer resin) can be in the form of flakes, granules, pellets, and/or a powder.

### Masterbatch Polyethylene

The at least one masterbatch polyethylene in the masterbatch composition can comprise any suitable polyethylene, including but not limited to those disclosed herein. In some embodiments, the at least one masterbatch polyethylene can be a homopolymer of polyethylene and/or a copolymer of polyethylene.

In certain embodiments of at least one masterbatch polyethylene, the homopolymer of polyethylene can comprise a polyethylene that consists substantially (e.g., at least 99.7 wt.-% or at least 99.8 wt.-%, based on the total weight of the polyethylene) of ethylene units. In some embodiments, only ethylene units in the homopolymer of polyethylene are detectable.

In other embodiments of at least one masterbatch polyethylene, the copolymer of polyethylene can be a polyethylene that comprises units derivable from ethylene as major components. In yet other embodiments, the copolymer of polyethylene can comprise at least 55.0 wt.-% units derivable from ethylene or at least 60.0 wt.-% of units derived from ethylene, based on the total weight of the polyethylene. In still other embodiments, the copolymer of polyethylene can comprise from 60.0 to 99.5 wt.-% or from 90.0 to 99.0 wt.-%, units derivable from ethylene, based on the total weight of the polyethylene. The comonomers present in a copolymer of polyethylene can be any suitable monomers, including but not limited to C3 to C10 α-olefins, preferably 1-propene, 1-butene, 1-hexene, 1-octene or butadiene.

In some embodiments, the at least one masterbatch polyethylene can have any suitable melting temperature. In certain embodiments, the at least one masterbatch polyethylene can have a melting temperature Tₘ of above 36° C. or above 105° C. In other embodiments, the melting temperature of the at least one masterbatch polyethylene can be from 36 to 200° C. or from 105 to 170° C.

In some embodiments, the at least one masterbatch polyethylene can have any suitable melt flow rate. In other embodiments, the at least one masterbatch polyethylene can have a melt index (190° C., 2.16 kg) measured according to ASTM D792 or a melt flow rate MFR (190° C., 2.16 kg) measured according to ISO 1133 of from 0.5 to 100.0 g/10 min. For example, the at least one masterbatch polyethylene can have a melt index (190° C., 2.16 kg) measured according to ASTM

D792 or a melt flow rate MFR (190° C., 2.16 kg) measured according to ISO 1133 of from 0.5 to 90.0 g/10 min, from 0.5 to 80.0 g/10 min, from 0.5 to 20.0 g/10 min, from 5.0 to 90.0 g/10 min, or from 10.0 to 80.0 g/10 min.

In some embodiments, the at least one masterbatch polyethylene can comprise LDPE (low density polyethylene), LLDPE (linear low density polyethylene), VLDPE (very low density polyethylene), ULDPE (ultralow density polyethylene), MDPE (medium density polyethylene), HDPE (high density polyethylene), UHMWPE (ultrahigh molecular weight polyethylene), or mixtures thereof. Examples of at least one masterbatch polyethylenes that can be used include, but are not limited to, those obtained from Chevron Phillips Chemical Company (e.g., Marlex 1017 polyethylene), Dow Chemical, Exxon Mobile, and other companies. Examples of at least one masterbatch polyethylenes that can be used include, but are not limited to, Marlex 1017 polyethylene, LDPE-4010, LDPE-200.48, Lyondell Basel! Lucalen A2700M and Lucalen A2910M,

In other embodiments, the density of the at least one masterbatch polyethylene can be, for example, 0.850, 0.860, 0.870, 0.880, 0.890, 0.895, 0.900, 0.905, 0.910, 0.915, 0.920, 0.925, 0.930, 0.935, 0.940, 0.945, 0.950, 0.955, 0.960, 0.970, or 0.980 g/cm³. In still other embodiments, the density of the at least one masterbatch polyethylene can be, for example, from 0.850 to 0.975 g/cm³, from 0.890 to 0.950 g/cm³, from 0.895 to 0.940 g/cm³, from 0.900 to 0.935 g/cm³, or from 0.905 to g/cm³. In yet other embodiments, the density of the at least one masterbatch polyethylene can be, for example, from 0.850 to 0.975, from 0.890 to 0.970 g/cm³, from 0.895 to 0.970 g/cm³, from 0.900 to 0.965 g/cm³, from 0.905 to 0.960 g/cm³, or from 0.920 to 0.960 g/cm 3 .

In some embodiments, low-density polyethylene (LDPE), very low density polyethylene (VLDPE) or linear low-density polyethylene (LLDPE), can have a melt index (190° C., 2.16 kg) measured according to ASTM D792 or a melt flow rate MFR (190° C., 2.16 kg) measured according to ISO 1133 of from 0.5 to 100.0 g/10 min. For example, a low-density polyethylene (LDPE), very low density polyethylene (VLDPE) or linear low-density polyethylene (LLDPE) can have a melt index (190° C., 2.16 kg) measured according to ASTM D792 or a melt flow rate MFR (190° C., 2.16 kg) measured according to ISO 1133 of from 5.0 to 90.0 g/10 min or from 10.0 to 80.0 g/10 min.

### Masterbatch Polypropylene

The at least one masterbatch polypropylene in the masterbatch composition can

comprise any suitable polypropylene, including but not limited to those disclosed herein. In some embodiments, the at least one masterbatch polypropylene can be a homopolymer of polypropylene and/or a copolymer of polypropylene.

In other embodiments, the at least one masterbatch polypropylene can be an isotactic polypropylene. The term “isotactic polypropylene” in the meaning of the present application means isotactic polypropylenes having a very low percentage, unavoidable and known to a person skilled in the art, of atactic polymer or polymer parts.

In other embodiments, the at least one masterbatch polypropylene (e.g., an isotactic polypropylene or a polypropylene homopolymer) can have a crystallinity percentage of at least 20%, from 30% to 90%, or from 45% to 85%, based on the total weight of the polypropylene.

In certain embodiments of the at least one masterbatch polypropylene, the homopolymer of polypropylene can be a polypropylene that consists substantially (e.g., at least 99.0 wt.-%, at least 99.5 wt.-%, or at least 99.8 wt.-%, based on the total weight of the polypropylene) of propylene units. In other embodiments, only propylene units are detectable in the homopolymer of polypropylene.

In some embodiments of the at least one masterbatch polypropylene, the copolymer of polypropylene can be a polypropylene that comprises units derivable from propylene as major components (e.g., at least 51.0 wt.-%, at least 55.0 wt.-%, at least 60.0 wt.-%, at least 70.0 wt.-%, at least 80.0 wt.-%, from 55.0 to 99.0 wt.-%, from 60.0 to 99.0 wt.-%, from 70.0 to 99.0 wt.% or from 80 to 99 wt.-%, based on the total weight of the polypropylene). In other embodiments, the copolymer of polypropylene can comprise any suitable units, such as but not limited to units derived from propylene and C2 and/or C4 α-olefin. In still other embodiments, the copolymer of polypropylene can comprise units derived from propylene and at least one α-olefin selected from ethylene 1-butene and butadiene. In yet other embodiments, the copolymer of polypropylene can comprise units derived from propylene and ethylene. In certain embodiments, the units derivable from propylene can constitute the main part of the polypropylene (e.g., at least 51.0 wt.-%, at least 55.0 wt.-%, at least 60.0 wt.-%, at least 70.0 wt.-%, at least 80.0 wt.-%, from 60.0 to 99.0 wt.-%, from 70.0 to 99.0 wt.% or from 80 to 99 wt.-%, based on the total weight of the polypropylene). In some embodiments, the amount of units derived from C2 and/or C4 α-olefin in the copolymer of polypropylene, is from 1.0 to 40.0 wt.-%, from 1.0 to 30.0 wt.-% or from 1.0 to 20.0 wt.-%, based on the total weight of the copolymer of polypropylene.

In certain embodiments, if the copolymer of polypropylene comprises only units derivable from propylene and ethylene, the amount of ethylene can be from 1.0 to 20.0 wt.-%, from 1.0 to 15.0 wt.-% or from 1.0 to 10.0 wt.-%, based on the total weight of the copolymer of polypropylene. In other embodiments, the amount of propylene can be from 80.0 to 99.0 wt.%, from 85.0 to 99.0 wt.-% or from 90.0 to 99.0 wt.-%, based on the total weight of the copolymer of polypropylene.

In some embodiments, the at least one masterbatch polypropylene can comprise Braskem Polypropylene FT200VVV, 20 MFR. Examples of polypropylenes that can be used include, but are not limited to, those obtained from Chevron Phillips Chemical Company, Dow Chemical, Exxon Mobile, and other companies.

In other embodiments, the density of the at least one masterbatch polypropylene (e.g., a polypropylene homopolymer or a polypropylene copolymer) can be, for example, 0.850, 0.860, 0.880, 0.890, 0.895, 0.900, 0.905, 0.910, 0.915, 0.920, 0.925, 0.930, 0.935, 0.940, 0.945, 0.955, 0.960, 0.970, or 0.980 g/cm³. In other embodiments, the density of the at least one masterbatch polypropylene (e.g., a polypropylene homopolymer or a polypropylene copolymer) can be, for example, from 0.850 to 0.975 g/cm³, from 0.890 to 0.950 g/cm³, from 0.895 to 0.950 g/cm3, from 0.895 to 0.940 g/cm³, from 0.916 to 0.946 g/cm³, from 0.936 to 0.946 g/cm³, from 0.900 to 0.935 g/cm³, or from 0.905 to 0.930 g/cm³.

In some embodiments, the at least one masterbatch polypropylene (e.g., a polypropylene homopolymer or a polypropylene copolymer) can have any suitable melt index (190° C., 2.16 kg) measured according to ASTM D792 or melt flow rate MFR (190° C., 2.16 kg) measured according to ISO 1133. In some embodiments, the at least one masterbatch polypropylene (e.g., a polypropylene homopolymer) can have a melt index (190° C., 2.16 kg) measured according to ASTM D792 or a melt flow rate MFR (190° C., 2.16 kg) measured according to ISO 1133 of from 0.5 to 100.0 g/10 min. For example, the at least one masterbatch polypropylene (e.g., a polypropylene homopolymer) can have a melt index (190° C., 2.16 kg) measured according to ASTM D792 or a melt flow rate MFR (190° C., 2.16 kg) measured according to ISO 1133 of from 5.0 to 90.0 g/10 min or from to 80.0 g/10 min.

In other embodiments, the at least one masterbatch polypropylene (e.g., an isotactic polypropylene or a polypropylene homopolymer) can have any suitable melt flow rate. In yet other embodiments, the at least one masterbatch polypropylene (e.g., an isotactic polypropylene or a polypropylene homopolymer) can have a melt index (190° C., 2.16 kg) measured according to ASTM D792 or a melt flow rate MFR (190° C., 2.16 kg) measured according to ISO 1133 of from 0.5 to 100.0 g/10 min. In still other embodiments, the at least one masterbatch polypropylene (e.g., an isotactic polypropylene ora polypropylene homopolymer) can have a melt index (190° C., 2.16 kg) measured according to ASTM D792 ora melt flow rate MFR (190° C., 2.16 kg) measured according to ISO 1133 of from 5.0 to 90.0 g/10 min or from 10.0 to 80.0 g/10 min. In some embodiments, the at least one masterbatch polypropylene (e.g., an isotactic polypropylene or a polypropylene homopolymer) can have a melt index (190° C., 2.16 kg) measured according to ASTM D792, a melt flow rate MFR (190 ° C., 2.16 kg) measured according to ISO 1133, ora melt flow rate MFR (190° C., -10 kg - 1.05mm) measured according to the amended standard NF T51-620 of at least 200 g/10 min. In other embodiments, the at least one masterbatch polypropylene (e.g., an isotactic polypropylene or a polypropylene homopolymer) can have a melt index (190° C., 2.16 kg) measured according to ASTM D792, a melt flow rate MFR (190° C., 2.16 kg) measured according to ISO 1133, or a melt flow rate MFR (190° C., −10 kg- 1.05mm) measured according to the amended standard NF T51-620 of at least 500 g/10 min.

In certain embodiments, the at least one masterbatch polypropylene can have a melting temperature Tₘ of above 36° C. or above 105° C. In other embodiments, the melting temperature of the at least one masterbatch polypropylene (e.g., an isotactic polypropylene or a polypropylene homopolymer) can be from 36 to 200° C. or from 105 to 170° C. In still other embodiments, Tₘ can be at least 170° C. In yet other embodiments, the melting temperature of the at least one masterbatch polypropylene (e.g., an isotactic polypropylene or a polypropylene homopolymer) can be from 140 to 200° C. or from 150 to 170° C.

### Calcium Carbonate Material

The first calcium carbonate material can be any suitable calcium carbonate material including but not limited to those described herein (e.g., the calcium carbonate material described in this section).

The second calcium carbonate material can be any suitable calcium carbonate material including but not limited to those described herein (e.g., the calcium carbonate material described in this section).

The first calcium carbonate material and the second calcium carbonate material can be the same or different.

In some embodiments, the calcium carbonate material comprises one calcium carbonate source. Alternatively, the calcium carbonate material can, in some examples, consist of, two or more calcium carbonate sources. For example, the calcium carbonate material comprises two or three calcium carbonate sources.

The term “calcium carbonate source” in the meaning of the present invention refers a material being selected from among (natural) ground calcium carbonate (GCC or NGCC), a precipitated calcium carbonate (PCC) and mixtures thereof.

GCC is understood to be a naturally occurring form of calcium carbonate, mined from sedimentary rocks such as dolomite, limestone or chalk, or from metamorphic marble rocks and can sometimes be processed through a treatment such as dry and/or wet grinding in the presence or absence of processing aids such as alkylated or non-alkylated, esterified or non-esterified polyacrylic acids, methacrylic acids and/or their salts as, or phosphates, dry ethers or hydroxygroup containing compounds such as glycerols, or polyethylenglycols, screening and/or fractionizing in wet and/or dry form, for example by a centrifuge, cyclone or classifier. In some embodiments, the GCC is selected from the group comprising marble, chalk, dolomite, limestone and mixtures thereof. Calcium carbonate of the PCC type can include synthetic calcium carbonate products

obtained by carbonation of a slurry of calcium hydroxide, commonly referred to in the art as a slurry of lime or milk of lime when derived from finely divided calcium oxide particles in water or by precipitation out of an ionic salt solution. PCC may be rhombohedral and/or scalenohedral and/or aragonitic; synthetic calcium carbonate or precipitated calcium carbonate comprising aragonitic, vateritic or calcitic mineralogical crystal forms or mixtures thereof.

In some embodiments, the one calcium carbonate source is (natural) ground calcium carbonate (GCC). In other embodiments, the calcium carbonate source is GCC being selected from the group comprising marble, chalk, dolomite, limestone and mixtures thereof.

In general, the calcium carbonate source comprises calcium carbonate in an amount of 50.0 wt %, based on the total weight of the calcium carbonate source.

In some embodiments, the at least one calcium carbonate source comprises calcium carbonate in an amount of 75.0 wt %, based on the total weight of the at least one calcium carbonate source. For example, the at least one calcium carbonate source comprises calcium carbonate in an amount of 90.0 wt %, or in an amount of 95.0 wt %, based on the total weight of the at least one calcium carbonate source. In some embodiments, the at least one calcium carbonate source comprises calcium carbonate in an amount from 97.0 to 99.9 wt %, based on the total weight of the at least one calcium carbonate source.

In some embodiments, the calcium carbonate material (e.g., the first calcium carbonate material, second calcium carbonate material, or both) can have a weight median particle size d₅₀ value of 0.1 μm, 0.2 μm, 0.3 μm, 0.4 μm, 0.5 μm, 0.6 μm, 0.7 μm, 0.8 μm, 0.9 μm, 1.0 μm, 1.5 μm, 2.0 μm, 2.5 μm, 3.0 μm, 3.5 μm, 4.0 μm, 4.5 μm, 5.0 μm, 6.0 μm, 7.0 μm, 8.0 μm, 9.0 μm, 10.0 μm, 11.0 μm, 12.0 μm, from 0.1 μm to 12.0 μm, 0.1 μm to 8.0 μm, from 1.0 μm to 12.0 μm, from 1.0 to μm, from 2.0 to 8.0 μm, from 0.4 μm to 1.0 μm, from 0.5 μm to 4.0 μm, 0.5 μm to 0.9 μm, from μm to 0.8 μm or of 0.7 μm, or from 0.5 μm to 4.0 μm, from 0.5 μm to 2.3 μm, from 1.1 μm to 1.7 μm, from 1.3 μm to 1.5 μm or of 1.4 μm, measured according to the sedimentation method. In certain embodiments, the calcium carbonate material (e.g., the first calcium carbonate material, second calcium carbonate material, or both) can have a top cut d₉₈ value of 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, no more than 25 μm, no more than 20 μm, no more than 18 μm, no more than 15 μm, no more than 10 μm, no more than 8 μm, no more than 6 μm, or no more than 4 μm. In other embodiments, the calcium carbonate material (e.g., the first calcium carbonate material, second calcium carbonate material, or both) can have a specific surface area (BET) of 0.1 m²/g, 0.2 m²/g, 0.3 m²/g, 0.4 m²/g, 0.5 m²/g, 0.6 m²/g, 0.7 m²/g, 0.8 m²/g, 0.9 m²/g, 1.0 m²/g, 1.5 m²/g, 2.0 m²/g, 2.5 m²/g, 3.0 m²/g, 3.5 m²/g, 4.0 m²/g, 4.5 m²/g, 5.0 m²/g, 6.0 m²/g, 7.0 m²/g, 8.0 m²/g, 9.0 m²/g, 10.0 m²/g, 11.0 m²/g, 12.0 m²/g, 13.0 m²/g, 14.0 m²/g, 15.0 m²/g, 16.0 m²/g, 17.0 m²/g, 18.0 m²/g, 19.0 m²/g, 20.0 m²/g, 21.0 m²/g, 22.0 m²/g, 23.0 m²/g, 24.0 m²/g, 25.0 m²/g, from 0.1 to 15.0 m²/g, from 1 m²/g to 25 m²/g, 5 m²/g to 15 m²/g or 8 m²/g to 13 m²/g, or 2 m²/g to 15 m²/g or from 3 m²/g to 10 m²/g as measured by the BET nitrogen method.

In some embodiments, at least one of the at least one calcium carbonate source (e.g., ground calcium carbonate (GCC) and/or precipitated calcium carbonate (PCC)) can have a weight median particle size d₅₀ value of 0.1 μm, 0.2 μm, 0.3 μm, 0.4 μm, 0.5 μm, 0.6 μm, 0.7 μm, 0.8 μm, 0.9 μm, 1.0 μm, 1.5 μm, 2.0 μm, 2.5 μm, 3.0 μm, 3.5 μm, 4.0 μm, 4.5 μm, 5.0 μm, 6.0 μm, 7.0 μm, 8.0 μm, 9.0 μm, 10.0 μm, 11.0 μm, 12.0 μm, from 0.1 μm to 12.0 μm, 0.1 μm to 8.0 μm, from 1.0 μm to 12.0 μm, from 1.0 to 10.0 μm, from 2.0 to 8.0 μm, from 0.4 μm to 1.0 μm, from 0.5 μm to 4.0 μm, 0.5 μm to 0.9 μm, from 0.6 μm to 0.8 μm or of 0.7 μm, or from 0.5 μm to 4.0 μm, from 0.5 μm to 2.3 μm, from 1.1 μm to 1.7 μm, from 1.3 μm to 1.5 μm or of 1.4 μm, measured according to the sedimentation method. In certain embodiments, at least one of the at least one calcium carbonate source (e.g., ground calcium carbonate (GCC) and/or precipitated calcium carbonate (PCC)) can have a top cut d₉₈ value of 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, no more than 25 μm, no more than 20 μm, no more than 18 μm, no more than 15 μm, no more than 10 μm, no more than 8 μm, no more than 6 μm, or no more than 4 μm. In other embodiments, at least one of the at least one calcium carbonate source (e.g., ground calcium carbonate (GCC) and/or precipitated calcium carbonate (PCC)) can have a specific surface area (BET) of 0.1 m²/g, 0.2 m²/g, 0.3 m²/g, 0.4 m²/g, 0.5 m²/g, 0.6 m²/g, 0.7 m²/g, 0.8 m²/g, 0.9 m²/g, 1.0 m²/g, 1.5 m²/g, 2.0 m²/g, 2.5 m²/g, 3.0 m²/g, 3.5 m²/g, 4.0 m²/g, 4.5 m²/g, 5.0 m²/g, 6.0 m²/g, 7.0 m²/g, 8.0 m²/g, 9.0 m²/g, 10.0 m²/g, 11.0 m²/g, 12.0 m²/g, 13.0 m²/g, 14.0 m²/g, 15.0 m²/g, 16.0 m²/g, 17.0 m²/g, 18.0 m²/g, 19.0 m²/g, 20.0 m²/g, 21.0 m²/g, 22.0 m²/g, 23.0 m²/g, 24.0 m²/g, 25.0 m²/g, from 0.1 to 15.0 m²/g, from 1 m²/g to 25 m²/g, 5 m²/g to 15 m²/g or 8 m²/g to 13 m²/g, or 2 m²/g to 15 m²/g or from 3 m²/g to 10 m²/g as measured by the BET nitrogen method.

In some embodiments, at least one of the at least one calcium carbonate source (e.g., ground calcium carbonate (GCC) and/or precipitated calcium carbonate (PCC)) has a weight median particle size dso value in the range from 1.0 μm to 12.0 μm, from 1.0 to 10.0 μm, from 2.0 to 8.0 μm, from 0.4 μm to 1.0 μm, from 0.5 μm to 0.9 μm, from 0.6 μm to 0.8 μm or of 0.7 μm, measured according to the sedimentation method. In certain embodiments, at least one of the at least one calcium carbonate source (e.g., ground calcium carbonate (GCC) and/or precipitated calcium carbonate (PCC)) has a top cut d₉₈ value of 1 μm, 2 μm, 3 μm, 4 μm, 5 μm, 6 μm, 7 μm, 8 μm, 9 μm, μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, no more than 25 μm, no more than 20 μm, no more than 18 μm, no more than 15 μm, no more than 10 μm, no more than 8 μm, no more than 6 μm, or no more than 4 μm. In other embodiments, the at least one calcium carbonate source has a specific surface area (BET) of from 0.1 to 15.0 m²/g, from 1 m²/g to 25 m²/g, 5 m²/g to 15 m²/g or 8 m²/g to 13 m²/g as measured by the BET nitrogen method.

In some embodiments, the calcium carbonate material has least one calcium carbonate source, such as ground calcium carbonate (GCC) and/or precipitated calcium carbonate (PCC), and in some embodiments has a weight median particle size dso value in the range from 1.0 μm to 12.0 μm, from 1.0 to 10.0 μm, from 2.0 to 8.0 μm, from 0.4 μm to 1.0 μm, from 0.5 μm to 0.9 μm, from 0.6 μm to 0.8 μm or of 0.7 μm, measured according to the sedimentation method and/or a specific surface area (BET) of from 0.1 to 15.0 m²/g, from 1 m²/g to 25 m²/g, 5 m²/g to 15 m²/g or 8 m²/g to 13 m²/g as measured by the BET nitrogen method.

In certain embodiments, the at least one calcium carbonate source, such as ground calcium carbonate (GCC) and/or precipitated calcium carbonate (PCC), has a weight median particle size dso value in the range from 1.0 μm to 12.0 μm, from 1.0 to 10.0 μm, from 2.0 to 8.0 μm, from 0.5 μm to 2.3 μm, from 1.1 μm to 1.7 μm, from 1.3 μm to 1.5 μm or of 1.4 μm, measured according to the sedimentation method and/or a specific surface area (BET) of from 0.1 to 15.0 m²/g, from 1 m²/g to 25 m²/g, 2 m²/g to 15 m²/g or from 3 m²/g to 10 m²/g, as measured by the BET nitrogen method.

In some embodiments, the calcium carbonate material has least one calcium carbonate source, such as ground calcium carbonate (GCC) and/or precipitated calcium carbonate (PCC), in some embodiments has a weight median particle size dso value in the range from 1.0 μm to 12.0 μm, from 1.0 to 10.0 μm, or from 2.0 to 8.0 μm and/or a specific surface area (BET) of from 0.1 to 15.0 m²/g as measured by the BET nitrogen method. In certain embodiments, the at least one calcium carbonate source, such as ground calcium carbonate (GCC) and/or precipitated calcium carbonate (PCC), has a weight median particle size dso value in the range from 1.0 μm to 12.0 μm, from 1.0 to μm, or from 2.0 to 8.0 μm or a specific surface area (BET) of from 0.1 to 15.0 m²/g as measured by the BET nitrogen method. Alternatively, the at least one calcium carbonate source, such as ground calcium carbonate (GCC) and/or precipitated calcium carbonate (PCC), has a weight median particle size d₅₀ value in the range from 1.0 μm to 12.0 μm, from 1.0 to 10.0 μm, or from 2.0 to 8.0 μm and a specific surface area (BET) of from 0.1 to 15.0 m²/g as measured by the BET nitrogen method.

In some embodiments, the calcium carbonate of the first calcium carbonate material has a weight median particle diameter d₅₀ of from 0.4 μm to 1 μm, preferably from 0.5 μm to 0.9 μm, more preferably from 0.6 μm to 0.8 μm and most preferably of 0.7 μm, measured according to the sedimentation method.

In other embodiments, the calcium carbonate of the second calcium carbonate material has a weight median particle diameter d₅₀ of from 0.4 μm to 1 μm, preferably from 0.5 μm to μm, more preferably from 0.6 μm to 0.8 μm and most preferably of 0.7 μm, measured according to the sedimentation method.

In some embodiments, the calcium carbonate of the first calcium carbonate material has a weight median particle diameter d₅₀ of from 0.1 μm to 8.0 μm, preferably from 0.1 μm to 4.0 μm, preferably from 0.5 μm to 2.3 μm, preferably from 1.1 μm to 1.7 μm, more preferably from 1.3 μm to 1.5 μm and most preferably of 1.4 μm, measured according to the sedimentation method.

In other embodiments, the calcium carbonate of the second calcium carbonate material has a weight median particle diameter d₅₀ of from 0.1 μm to 8.0 μm, preferably from 0.1 μm to 4.0 μm, preferably from 0.5 μm to 2.3 μm, preferably from 1.1 μm to 1.7 μm, more preferably from 1.3 μm to 1.5 μm and most preferably of 1.4 μm, measured according to the sedimentation method.

In certain embodiments, the calcium carbonate material (e.g., the first calcium carbonate material, second calcium carbonate material, or both) can be surface reacted. For example, a surface-reacted calcium carbonate may be prepared by providing a calcium carbonate material (e.g., GCC or PCC) in form of an aqueous suspension, and adding an acid to said suspension. Suitable acids are, for example, sulfuric acid, hydrochloric acid, phosphoric acid, citric acid, oxalic acid, or a mixture thereof. In a next step, the calcium carbonate can sometimes be treated with gaseous carbon dioxide. If a strong acid such as sulfuric acid or hydrochloric acid is used for the acid treatment step, the carbon dioxide can form automatically in situ. Alternatively or additionally, the carbon dioxide can sometimes be supplied from an external source. Surface-reacted calcium carbonates are described, for example, in US 2012/0031576 A1, WO 2009/074492 A1, EP 2 264 109 A1, EP 2 070 991 A1, or EP 2 264 108 A1, which are herein incorporated by reference in their entirety.

It is appreciated that the calcium carbonate material (e.g., the first calcium carbonate material, second calcium carbonate material, or both), such as ground calcium carbonate (GCC) and/or precipitated calcium carbonate (PCC), may in some embodiments be surface treated. For example, the calcium carbonate material, such as ground calcium carbonate (GCC) and/or precipitated calcium carbonate (PCC), can be surface treated.

If the calcium carbonate material, such as ground calcium carbonate (GCC) and/or precipitated calcium carbonate (PCC), is/are surface treated, it is appreciated that, in certain embodiments, approximately 1% or at least 0.1% or at least 1% or from 0.1% to 3% of the accessible surface area of the calcium carbonate material is covered by a coating comprising the surface treatment agent.

In some embodiments, the calcium carbonate material, such as ground calcium carbonate (GCC) and/or precipitated calcium carbonate (PCC), can be surface treated with at least one aliphatic (e.g., linear or branched) carboxylic acid having a total amount of carbon atoms from C4 to C24. Accordingly, in certain embodiments, approximately 1%, at least 0.1%, at least 1%, or from to 3% of the accessible surface area of the calcium carbonate material is covered by a coating comprising at least one aliphatic carboxylic acid having a total amount of carbon atoms from C4 to C24 and/or reaction products thereof.

The term “reaction products” of the aliphatic carboxylic acid in the meaning of the present invention refers to products obtained by contacting the calcium carbonate material with the at least one aliphatic carboxylic acid. Said reaction products are formed between at least a part of the applied at least one aliphatic carboxylic acid and reactive molecules located at the surface of the calcium carbonate material.

The aliphatic carboxylic acid in the meaning of the present invention may be selected from one or more straight chain, branched chain, saturated, unsaturated and/or alicyclic carboxylic acids. In certain embodiments, the aliphatic carboxylic acid is a monocarboxylic acid, i.e. the aliphatic carboxylic acid is characterized in that a single carboxyl group is present. Said carboxyl group is placed at the end of the carbon skeleton.

In some embodiments of the present invention, the aliphatic carboxylic acid is selected from saturated unbranched carboxylic acids, that is to say the aliphatic carboxylic acid can be selected from the group of carboxylic acids consisting of pentanoic acid, hexanoic acid, heptanoic acid, octanoic acid, nonanoic acid, decanoic acid, undecanoic acid, lauric acid, tridecanoic acid, myristic acid, pentadecanoic acid, palmitic acid, heptadecanoic acid, stearic acid, nonadecanoic acid, arachidic acid, heneicosylic acid, behenic acid, tricosylic acid, lignoceric acid and mixtures thereof.

In other embodiments, the aliphatic carboxylic acid is selected from the group consisting of octanoic acid, decanoic acid, lauric acid, myristic acid, palmitic acid, stearic acid, arachidic acid and mixtures thereof. In some embodiments, the aliphatic carboxylic acid is selected from the group consisting of myristic acid, palmitic acid, stearic acid and mixtures thereof.

For example, the aliphatic carboxylic acid is stearic acid.

Additionally or alternatively, the calcium carbonate material, such as ground calcium carbonate (GCC) and/or precipitated calcium carbonate (PCC), can be surface treated with at least one mono-substituted succinic anhydride, at least one mono-substituted succinic acid, at least one reaction product of mono-substituted succinic anhydride and/or at least one reaction product of mono-substituted succinic acid. In other embodiments, approximately 1%, at least 0.1%, at least 1%, or from to 3% of the accessible surface area of the calcium carbonate of the first calcium carbonate material, of the second calcium carbonate material, or both, is covered by a coating comprising at least one mono-substituted succinic anhydride, at least one mono-substituted succinic acid, at least one reaction product of mono-substituted succinic anhydride and/or at least one reaction product of mono-substituted succinic acid.

In certain embodiments, approximately 1%, at least 0.1%, at least 1%, or from 0.1% to 3% of the accessible surface area of the calcium carbonate of the first calcium carbonate material, of the second calcium carbonate material, or both, is covered by a coating comprising at least one mono-substituted succinic anhydride including but not limited to at least one mono-substituted succinic anhydride consisting of succinic anhydride mono-substituted with a group selected from a linear, branched, aliphatic and cyclic group having a total amount of carbon atoms from C2 to C30 in the substituent. Accordingly, in certain embodiments, approximately 1%, at least 0.1%, at least 1%, or from 0.1% to 3% of the accessible surface area of the calcium carbonate material is covered by a coating comprising at least one mono-substituted succinic anhydride consisting of succinic anhydride mono-substituted with a group selected from a linear, branched, aliphatic and cyclic group having a total amount of carbon atoms from C2 to C30 in the substituent and/or reaction products thereof.

The term “reaction products” of the mono-substituted succinic anhydride in the meaning of the present invention refers to products obtained by contacting the calcium carbonate material with the at least one mono-substituted succinic anhydride. Said reaction products are formed between at least a part of the applied at least one mono-substituted succinic anhydride and reactive molecules located at the surface of the at least one acidic inorganic filler material and/or the at least one alkaline inorganic filler material.

For example, the at least one mono-substituted succinic anhydride consists of succinic anhydride mono-substituted with one group being a linear alkyl group having a total amount of carbon atoms from C2 to C30, from C3 to C20, or from C4 to C18 in the substituent or a branched alkyl group having a total amount of carbon atoms from C3 to C30, from C3 to C20, or from C4 to C18 in the substituent.

For example, the at least one mono-substituted succinic anhydride consists of succinic anhydride mono-substituted with one group being a linear alkyl group having a total amount of carbon atoms from C2 to C30, from C3 to C20, or from C4 to C18 in the substituent. Additionally or alternatively, the at least one mono-substituted succinic anhydride consists of succinic anhydride mono-substituted with one group being a branched alkyl group having a total amount of carbon atoms from C3 to C30, from C3 to C20, or from C4 to C18 in the substituent.

The term “alkyl” in the meaning of the present invention refers to a linear or branched, saturated organic compound composed of carbon and hydrogen. In other words, “alkyl mono-substituted succinic anhydrides” are composed of linear or branched, saturated hydrocarbon chains containing a pendant succinic anhydride group.

In some embodiments, the at least one mono-substituted succinic anhydride is at least one linear or branched alkyl mono-substituted succinic anhydride. For example, the at least one alkyl mono-substituted succinic anhydride is selected from the group comprising ethylsuccinic anhydride, propylsuccinic anhydride, butylsuccinic anhydride, triisobutyl succinic anhydride, pentylsuccinic anhydride, hexylsuccinic anhydride, heptylsuccinic anhydride, octylsuccinic anhydride, nonylsuccinic anhydride, decyl succinic anhydride, dodecyl succinic anhydride, hexadecanyl succinic anhydride, octadecanyl succinic anhydride, and mixtures thereof.

It is appreciated that e.g. the term “butylsuccinic anhydride” comprises linear and branched butylsuccinic anhydride(s). One specific example of linear butylsuccinic anhydride(s) is n-butylsuccinic anhydride. Specific examples of branched butylsuccinic anhydride(s) are iso-butylsuccinic anhydride, sec-butylsuccinic anhydride and/or tert-butylsuccinic anhydride.

Furthermore, it is appreciated that e.g. the term “hexadecanyl succinic anhydride” comprises linear and branched hexadecanyl succinic anhydride(s). One specific example of linear hexadecanyl succinic anhydride(s) is n-hexadecanyl succinic anhydride. Specific examples of branched hexadecanyl succinic anhydride(s) are 14-methylpentadecanyl succinic anhydride, 13-methylpentadecanyl succinic anhydride, 12-methylpentadecanyl succinic anhydride, 11-methylpentadecanyl succinic anhydride, 10-methylpentadecanyl succinic anhydride, 9-methylpentadecanyl succinic anhydride, 8-methylpentadecanyl succinic anhydride, 7-methylpentadecanyl succinic anhydride, 6-methylpentadecanyl succinic anhydride, 5-methylpentadecanyl succinic anhydride, 4-methylpentadecanyl succinic anhydride, 3-methylpentadecanyl succinic anhydride, 2-methylpentadecanyl succinic anhydride, 1-methylpentadecanyl succinic anhydride, 13-ethylbutadecanyl succinic anhydride, 12-ethylbutadecanyl succinic anhydride, 11-ethylbutadecanyl succinic anhydride, 10-ethylbutadecanyl succinic anhydride, 9-ethylbutadecanyl succinic anhydride, 8-ethylbutadecanyl succinic anhydride, 7-ethylbutadecanyl succinic anhydride, 6-ethylbutadecanyl succinic anhydride, 5-ethylbutadecanyl succinic anhydride, 4-ethylbutadecanyl succinic anhydride, 3-ethylbutadecanyl succinic anhydride, 2-ethylbutadecanyl succinic anhydride, 1-ethylbutadecanyl succinic anhydride, 2-butyldodecanyl succinic anhydride, 1-hexyldecanyl succinic anhydride, 1-hexyl-2-decanyl succinic anhydride, 2-hexyldecanyl succinic anhydride, 6,12-dimethylbutadecanyl succinic anhydride, 2,2-diethyldodecanyl succinic anhydride, 4,8,12-trimethyltridecanyl succinic anhydride, 2,2,4,6,8-pentamethylundecanyl succinic anhydride, 2-ethyl-4-methyl-2-(2-methylpentyl)-heptyl succinic anhydride and/or 2-ethyl-4,6-dimethyl-2-propylnonyl succinic anhydride.

Furthermore, it is appreciated that e.g. the term “octadecanyl succinic anhydride” comprises linear and branched octadecanyl succinic anhydride(s). One specific example of linear octadecanyl succinic anhydride(s) is n-octadecanyl succinic anhydride. Specific examples of branched hexadecanyl succinic anhydride(s) are 16-methylheptadecanyl succinic anhydride, 15-methylheptadecanyl succinic anhydride, 14-methylheptadecanyl succinic anhydride, 13-methylheptadecanyl succinic anhydride, 12-methylheptadecanyl succinic anhydride, 11-methylheptadecanyl succinic anhydride, 10-methylheptadecanyl succinic anhydride, 9-methylheptadecanyl succinic anhydride, 8-methylheptadecanyl succinic anhydride, 7-methylheptadecanyl succinic anhydride, 6-methylheptadecanyl succinic anhydride, 5-methylheptadecanyl succinic anhydride, 4-methylheptadecanyl succinic anhydride, 3-methylheptadecanyl succinic anhydride, 2-methylheptadecanyl succinic anhydride, 1-methylheptadecanyl succinic anhydride, 14-ethylhexadecanyl succinic anhydride, 13-ethylhexadecanyl succinic anhydride, 12-ethylhexadecanyl succinic anhydride, 11-ethylhexadecanyl succinic anhydride, 10-ethylhexadecanyl succinic anhydride, 9-ethylhexadecanyl succinic anhydride, 8-ethylhexadecanyl succinic anhydride, 7-ethylhexadecanyl succinic anhydride, 6-ethylhexadecanyl succinic anhydride, 5-ethylhexadecanyl succinic anhydride, 4-ethylhexadecanyl succinic anhydride, 3-ethylhexadecanyl succinic anhydride, 2-ethylhexadecanyl succinic anhydride, 1-ethylhexadecanyl succinic anhydride, 2-hexyldodecanyl succinic anhydride, 2-heptylundecanyl succinic anhydride, iso-octadecanyl succinic anhydride and/or 1-octyl-2-decanyl succinic anhydride.

In some embodiments, the at least one alkyl mono-substituted succinic anhydride is selected from the group comprising butylsuccinic anhydride, hexylsuccinic anhydride, heptylsuccinic anhydride, octylsuccinic anhydride, hexadecanyl succinic anhydride, octadecanyl succinic anhydride, and mixtures thereof.

In some embodiments, the at least one mono-substituted succinic anhydride is one kind of alkyl mono-substituted succinic anhydride. For example, the one alkyl mono-substituted succinic anhydride is butylsuccinic anhydride. Alternatively, the one alkyl mono-substituted succinic anhydride is hexylsuccinic anhydride. Alternatively, the one alkyl mono-substituted succinic anhydride is heptylsuccinic anhydride or octylsuccinic anhydride. Alternatively, the one alkyl mono-substituted succinic anhydride is hexadecanyl succinic anhydride. For example, the one alkyl mono-substituted succinic anhydride is linear hexadecanyl succinic anhydride such as n-hexadecanyl succinic anhydride or branched hexadecanyl succinic anhydride such as 1-hexyl-2-decanyl succinic anhydride. Alternatively, the one alkyl mono-substituted succinic anhydride is octadecanyl succinic anhydride. For example, the one alkyl mono-substituted succinic anhydride is linear octadecanyl succinic anhydride such as n-octadecanyl succinic anhydride or branched octadecanyl succinic anhydride such as iso-octadecanyl succinic anhydride or 1-octyl-2-decanyl succinic anhydride.

In some embodiments, the one alkyl mono-substituted succinic anhydride is butylsuccinic anhydride such as n-butylsuccinic anhydride.

In some embodiments, the at least one mono-substituted succinic anhydride is a mixture of two or more kinds of alkyl mono-substituted succinic anhydrides. For example, the at least one mono-substituted succinic anhydride is a mixture of two or three kinds of alkyl mono-substituted succinic anhydrides.

In some embodiments, the at least one mono-substituted succinic anhydride consists of succinic anhydride mono-substituted with one group being a linear alkenyl group having a total amount of carbon atoms from C2 to C30, from C3 to C20, or from C4 to C18 in the substituent or a branched alkenyl group having a total amount of carbon atoms from C3 to C30, from C4 to C20, or from C4 to C18 in the substituent.

The term “alkenyl” in the meaning of the present invention refers to a linear or branched, unsaturated organic compound composed of carbon and hydrogen. Said organic compound further contains at least one double bond in the substituent, such as one double bond. In other words, “alkenyl mono-substituted succinic anhydrides” are composed of linear or branched, unsaturated hydrocarbon chains containing a pendant succinic anhydride group. It is appreciated that the term “alkenyl” in the meaning of the present invention includes the cis and trans isomers. In some embodiments, the at least one mono-substituted succinic anhydride is at

least one linear or branched alkenyl mono-substituted succinic anhydride. For example, the at least one alkenyl mono-substituted succinic anhydride is selected from the group comprising ethenylsuccinic anhydride, propenylsuccinic anhydride, butenylsuccinic anhydride, triisobutenyl succinic anhydride, pentenylsuccinic anhydride, hexenylsuccinic anhydride, heptenylsuccinic anhydride, octenylsuccinic anhydride, nonenylsuccinic anhydride, decenyl succinic anhydride, dodecenyl succinic anhydride, hexadecenyl succinic anhydride, octadecenyl succinic anhydride, and mixtures thereof.

Accordingly, it is appreciated that e.g. the term “hexadecenyl succinic anhydride” comprises linear and branched hexadecenyl succinic anhydride(s). One specific example of linear hexadecenyl succinic anhydride(s) is n-hexadecenyl succinic anhydride such as 14-hexadecenyl succinic anhydride, 13-hexadecenyl succinic anhydride, 12-hexadecenyl succinic anhydride, 11-hexadecenyl succinic anhydride, 10-hexadecenyl succinic anhydride, 9-hexadecenyl succinic anhydride, 8-hexadecenyl succinic anhydride, 7-hexadecenyl succinic anhydride, 6-hexadecenyl succinic anhydride, 5-hexadecenyl succinic anhydride, 4-hexadecenyl succinic anhydride, 3-hexadecenyl succinic anhydride and/or 2-hexadecenyl succinic anhydride. Specific examples of branched hexadecenyl succinic anhydride(s) are 14-methyl-9-pentadecenyl succinic anhydride, 14-methyl-2-pentadecenyl succinic anhydride, 1-hexyl-2-decenyl succinic anhydride and/or iso-hexadecenyl succinic anhydride.

Furthermore, it is appreciated that e.g. the term “octadecenyl succinic anhydride” comprises linear and branched octadecenyl succinic anhydride(s). One specific example of linear octadecenyl succinic anhydride(s) is n-octadecenyl succinic anhydride such as 16-octadecenyl succinic anhydride, 15-octadecenyl succinic anhydride, 14-octadecenyl succinic anhydride, 13-octadecenyl succinic anhydride, 12-octadecenyl succinic anhydride, 11-octadecenyl succinic anhydride, 10-octadecenyl succinic anhydride, 9-octadecenyl succinic anhydride, 8-octadecenyl succinic anhydride, 7-octadecenyl succinic anhydride, 6-octadecenyl succinic anhydride, 5-octadecenyl succinic anhydride, 4-octadecenyl succinic anhydride, 3-octadecenyl succinic anhydride and/or 2-octadecenyl succinic anhydride. Specific examples of branched octadecenyl succinic anhydride(s) are 16-methyl-9-heptadecenyl succinic anhydride, 16-methyl-7-heptadecenyl succinic anhydride, 1-octyl-2-decenyl succinic anhydride and/or iso-octadecenyl succinic anhydride.

In some embodiments, the at least one alkenyl mono-substituted succinic anhydride is selected from the group comprising hexenylsuccinic anhydride, octenylsuccinic anhydride, hexadecenyl succinic anhydride, octadecenyl succinic anhydride, and mixtures thereof.

In some embodiments, the at least one mono-substituted succinic anhydride is one alkenyl mono-substituted succinic anhydride. For example, the one alkenyl mono-substituted succinic anhydride is hexenylsuccinic anhydride. Alternatively, the one alkenyl mono-substituted succinic anhydride is octenylsuccinic anhydride. Alternatively, the one alkenyl mono-substituted succinic anhydride is hexadecenyl succinic anhydride. For example, the one alkenyl mono-substituted succinic anhydride is linear hexadecenyl succinic anhydride such as n-hexadecenyl succinic anhydride or branched hexadecenyl succinic anhydride such as 1-hexyl-2-decenyl succinic anhydride. Alternatively, the one alkenyl mono-substituted succinic anhydride is octadecenyl succinic anhydride. For example, the one alkyl mono-substituted succinic anhydride is linear octadecenyl succinic anhydride such as n-octadecenyl succinic anhydride or branched octadecenyl succinic anhydride such iso-octadecenyl succinic anhydride, or 1-octyl-2-decenyl succinic anhydride.

In some embodiments, the one alkenyl mono-substituted succinic anhydride is linear octadecenyl succinic anhydride such as n-octadecenyl succinic anhydride. In other embodiments, the one alkenyl mono-substituted succinic anhydride is linear octenylsuccinic anhydride such as n-octenylsuccinic anhydride.

If the at least one mono-substituted succinic anhydride is one alkenyl mono-substituted succinic anhydride, it is appreciated that the one alkenyl mono-substituted succinic anhydride is present in an amount of 95 wt % or of 96.5 wt %, based on the total weight of the at least one mono-substituted succinic anhydride provided in step b).

In some embodiments, the at least one mono-substituted succinic anhydride is a mixture of two or more kinds of alkenyl mono-substituted succinic anhydrides. For example, the at least one mono-substituted succinic anhydride is a mixture of two or three kinds of alkenyl mono-substituted succinic anhydrides.

In some embodiments, the at least one mono-substituted succinic anhydride is a mixture of two or more kinds of alkenyl mono-substituted succinic anhydrides comprising linear hexadecenyl succinic anhydride(s) and linear octadecenyl succinic anhydride(s). Alternatively, the at least one mono-substituted succinic anhydride is a mixture of two or more kinds of alkenyl mono-substituted succinic anhydrides comprising branched hexadecenyl succinic anhydride(s) and branched octadecenyl succinic anhydride(s). For example, the one or more hexadecenyl succinic anhydride is linear hexadecenyl succinic anhydride like n-hexadecenyl succinic anhydride and/or branched hexadecenyl succinic anhydride like 1-hexyl-2-decenyl succinic anhydride. Additionally or alternatively, the one or more octadecenyl succinic anhydride is linear octadecenyl succinic anhydride like n-octadecenyl succinic anhydride and/or branched octadecenyl succinic anhydride like iso-octadecenyl succinic anhydride and/or 1-octyl-2-decenyl succinic anhydride.

It is also appreciated that the at least one mono-substituted succinic anhydride may be a mixture of at least one alkyl mono-substituted succinic anhydrides and at least one alkenyl mono-substituted succinic anhydrides.

If the at least one mono-substituted succinic anhydride is a mixture of at least one alkyl mono-substituted succinic anhydrides and at least one alkenyl mono-substituted succinic anhydrides, it is appreciated that the alkyl substituent of the of at least one alkyl mono-substituted succinic anhydrides and the alkenyl substituent of the of at least one alkenyl mono-substituted succinic anhydrides are the same, in some embodiments. For example, the at least one mono-substituted succinic anhydride is a mixture of ethylsuccinic anhydride and ethenylsuccinic anhydride. Alternatively, the at least one mono-substituted succinic anhydride is a mixture of propylsuccinic anhydride and propenylsuccinic anhydride. Alternatively, the at least one mono-substituted succinic anhydride is a mixture of butylsuccinic anhydride and butenylsuccinic anhydride. Alternatively, the at least one mono-substituted succinic anhydride is a mixture of triisobutyl succinic anhydride and triisobutenyl succinic anhydride. Alternatively, the at least one mono-substituted succinic anhydride is a mixture of pentylsuccinic anhydride and pentenylsuccinic anhydride. Alternatively, the at least one mono-substituted succinic anhydride is a mixture of hexylsuccinic anhydride and hexenylsuccinic anhydride. Alternatively, the at least one mono-substituted succinic anhydride is a mixture of heptylsuccinic anhydride and heptenylsuccinic anhydride. Alternatively, the at least one mono-substituted succinic anhydride is a mixture of octylsuccinic anhydride and octenylsuccinic anhydride. Alternatively, the at least one mono-substituted succinic anhydride is a mixture of nonylsuccinic anhydride and nonenylsuccinic anhydride. Alternatively, the at least one mono-substituted succinic anhydride is a mixture of decyl succinic anhydride and decenyl succinic anhydride. Alternatively, the at least one mono-substituted succinic anhydride is a mixture of dodecyl succinic anhydride and dodecenyl succinic anhydride. Alternatively, the at least one mono-substituted succinic anhydride is a mixture of hexadecanyl succinic anhydride and hexadecenyl succinic anhydride. For example, the at least one mono-substituted succinic anhydride is a mixture of linear hexadecanyl succinic anhydride and linear hexadecenyl succinic anhydride or a mixture of branched hexadecanyl succinic anhydride and branched hexadecenyl succinic anhydride. Alternatively, the at least one mono-substituted succinic anhydride is a mixture of octadecanyl succinic anhydride and octadecenyl succinic anhydride. For example, the at least one mono-substituted succinic anhydride is a mixture of linear octadecanyl succinic anhydride and linear octadecenyl succinic anhydride or a mixture of branched octadecanyl succinic anhydride and branched octadecenyl succinic anhydride.

In some embodiments, the at least one mono-substituted succinic anhydride is a mixture of nonylsuccinic anhydride and nonenylsuccinic anhydride.

If the at least one mono-substituted succinic anhydride is a mixture of at least one alkyl mono-substituted succinic anhydrides and at least one alkenyl mono-substituted succinic anhydrides, the weight ratio between the at least one alkyl mono-substituted succinic anhydride and the at least one alkenyl mono-substituted succinic anhydride is from 90:10 to 10:90 (wtY0/wt'Yo). For example, the weight ratio between the at least one alkyl mono-substituted succinic anhydride and the at least one alkenyl mono-substituted succinic anhydride is from 70:30 to 30:70 (wt')/0/wV/0) or from 60:40 to 40:60.

Additionally or alternatively, the calcium carbonate material, such as ground calcium carbonate (GCC) and/or precipitated calcium carbonate (PCC), can be surface treated with at least one a phosphoric acid ester blend. Accordingly, in certain embodiments, approximately 1%, at least at least 1%, or from 0.1% to 3% of the accessible surface area of the calcium carbonate material is covered by a coating comprising a phosphoric acid ester blend of one or more phosphoric acid mono-ester and/or reaction products thereof and one or more phosphoric acid di-ester and/or reaction products thereof.

The term “reaction products” of the phosphoric acid mono-ester and one or more phosphoric acid di-ester in the meaning of the present invention refers to products obtained by contacting the calcium carbonate material with the at least one phosphoric acid ester blend. Said reaction products are formed between at least a part of the applied phosphoric acid ester blend and reactive molecules located at the surface of the calcium carbonate material.

The term “phosphoric acid mono-ester” in the meaning of the present invention refers to an o-phosphoric acid molecule mono-esterified with one alcohol molecule selected from unsaturated or saturated, branched or linear, aliphatic or aromatic alcohols having a total amount of carbon atoms from C6 to C30, from C8 to C22, from C8 to C20, or from C8 to C18 in the alcohol substituent.

The term “phosphoric acid di-ester” in the meaning of the present invention refers to an o-phosphoric acid molecule di-esterified with two alcohol molecules selected from the same or different, unsaturated or saturated, branched or linear, aliphatic or aromatic alcohols having a total amount of carbon atoms from C6 to C30, from C8 to C22, from C8 to C20, or from C8 to C18 in the alcohol substituent.

It is appreciated that the expression “one or more” phosphoric acid mono-ester means that one or more kinds of phosphoric acid mono-ester may be present in the phosphoric acid ester blend.

Accordingly, it should be noted that the one or more phosphoric acid mono-ester may be one kind of phosphoric acid mono-ester. Alternatively, the one or more phosphoric acid mono-ester may be a mixture of two or more kinds of phosphoric acid mono-ester. For example, the one or more phosphoric acid mono-ester may be a mixture of two or three kinds of phosphoric acid mono-ester, like two kinds of phosphoric acid mono-ester.

In some embodiments, the one or more phosphoric acid mono-ester consists of an o-phosphoric acid molecule esterified with one alcohol selected from unsaturated or saturated, branched or linear, aliphatic or aromatic alcohols having a total amount of carbon atoms from C6 to C30 in the alcohol substituent. For example, the one or more phosphoric acid mono-ester consists of an o-phosphoric acid molecule esterified with one alcohol selected from unsaturated or saturated, branched or linear, aliphatic or aromatic alcohols having a total amount of carbon atoms from C8 to C22, from C8 to C20, or from C8 to C18 in the alcohol substituent.

In some embodiments, the one or more phosphoric acid mono-ester is selected from the group comprising hexyl phosphoric acid mono-ester, heptyl phosphoric acid mono-ester, octyl phosphoric acid mono-ester, 2-ethylhexyl phosphoric acid mono-ester, nonyl phosphoric acid mono-ester, decyl phosphoric acid mono-ester, undecyl phosphoric acid mono-ester, dodecyl phosphoric acid mono-ester, tetradecyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof. For example, the one or more phosphoric acid mono-ester is selected from the group

comprising 2-ethylhexyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof. In some embodiments, the one or more phosphoric acid mono-ester is 2-octyl-1-dodecylphosphoric acid mono-ester.

It is appreciated that the expression “one or more” phosphoric acid di-ester means that one or more kinds of phosphoric acid di-ester may be present in the coating layer of the at least one calcium carbonate-containing material and/or the phosphoric acid ester blend.

Accordingly, it should be noted that the one or more phosphoric acid di-ester may be one kind of phosphoric acid di-ester. Alternatively, the one or more phosphoric acid di-ester may be a mixture of two or more kinds of phosphoric acid di-ester. For example, the one or more phosphoric acid di-ester may be a mixture of two or three kinds of phosphoric acid di-ester, like two kinds of phosphoric acid di-ester.

In some embodiments, the one or more phosphoric acid di-ester consists of an o-phosphoric acid molecule esterified with two alcohols selected from unsaturated or saturated, branched or linear, aliphatic or aromatic alcohols having a total amount of carbon atoms from C6 to C30 in the alcohol substituent. For example, the one or more phosphoric acid di-ester consists of an o-phosphoric acid molecule esterified with two fatty alcohols selected from unsaturated or saturated, branched or linear, aliphatic or aromatic alcohols having a total amount of carbon atoms from C8 to C22, from C8 to C20, or from C8 to C18 in the alcohol substituent.

It is appreciated that the two alcohols used for esterifying the phosphoric acid may be independently selected from the same or different, unsaturated or saturated, branched or linear, aliphatic or aromatic alcohols having a total amount of carbon atoms from C6 to C30 in the alcohol substituent. In other words, the one or more phosphoric acid di-ester may comprise two substituents being derived from the same alcohols or the phosphoric acid di-ester molecule may comprise two substituents being derived from different alcohols.

In some embodiments, the one or more phosphoric acid di-ester consists of an o-phosphoric acid molecule esterified with two alcohols selected from the same or different, saturated and linear and aliphatic alcohols having a total amount of carbon atoms from C6 to C30, from C8 to C22, from C8 to C20, or from C8 to C18 in the alcohol substituent. Alternatively, the one or more phosphoric acid di-ester consists of an o-phosphoric acid molecule esterified with two alcohols selected from the same or different, saturated and branched and aliphatic alcohols having a total amount of carbon atoms from C6 to C30, from C8 to C22, from C8 to C20, or from C8 to C18 in the alcohol substituent.

In some embodiments, the one or more phosphoric acid di-ester is selected from the group comprising hexyl phosphoric acid di-ester, heptyl phosphoric acid di-ester, octyl phosphoric acid di-ester, 2-ethylhexyl phosphoric acid di-ester, nonyl phosphoric acid di-ester, decyl phosphoric acid di-ester, undecyl phosphoric acid di-ester, dodecyl phosphoric acid di-ester, tetradecyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and mixtures thereof.

For example, the one or more phosphoric acid di-ester is selected from the group comprising 2-ethylhexyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and

mixtures thereof. In some embodiments, the one or more phosphoric acid di-ester is 2-octyl-1-dodecylphosphoric acid di-ester.

In some embodiments, the one or more phosphoric acid mono-ester is selected from the group comprising 2-ethylhexyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof and the one or more phosphoric acid di-ester is selected from the group comprising 2-ethylhexyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and mixtures thereof.

For example, at least a part of the surface of the calcium carbonate material, such as ground calcium carbonate (GCC) and/or precipitated calcium carbonate (PCC), comprises a phosphoric acid ester blend of one phosphoric acid mono-ester and/or reaction products thereof and one phosphoric acid di-ester and/or reaction products thereof. In this case, the one phosphoric acid mono-ester is selected from the group comprising 2-ethylhexyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester and 2-octyl-1-dodecylphosphoric acid mono-ester, the one phosphoric acid di-ester is selected from the group comprising 2-ethylhexyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester and 2-octyl-1-dodecylphosphoric acid di-ester.

The phosphoric acid ester blend comprises the one or more phosphoric acid mono-ester and/or reaction products thereof to the one or more phosphoric acid di-ester and/or reaction products thereof in a specific molar ratio. In particular, the molar ratio of the one or more phosphoric acid mono-ester and/or reaction products thereof to the one or more phosphoric acid di-ester and/or reaction products thereof in the coating layer and/or the phosphoric acid ester blend is from 1:1 to 1:100, from 1:1.1 to 1:60, from 1:1.1 to 1:40, from 1:1.1 to 1:20, or from 1:1.1 to 1:10.

The wording “molar ratio of the one or more phosphoric acid mono-ester and salty reaction products thereof to the one or more phosphoric acid di-ester and salty reaction products thereof” in the meaning of the present invention refers to the sum of the molecular weight of the phosphoric acid mono-ester molecules and/or the sum of the molecular weight of the phosphoric acid mono-ester molecules in the reaction products thereof to the sum of the molecular weight of the phosphoric acid di-ester molecules and/or the sum of the molecular weight of the phosphoric acid di-ester molecules in the reaction products thereof.

In some embodiments, the phosphoric acid ester blend coated on at least a part of the surface of the calcium carbonate material, such as ground calcium carbonate (GCC) and/or precipitated calcium carbonate (PCC), may further comprise one or more phosphoric acid tri-ester and/or phosphoric acid and/or reaction products thereof.

The term “phosphoric acid tri-ester” in the meaning of the present invention refers to an o-phosphoric acid molecule tri-esterified with three alcohol molecules selected from the same or different, unsaturated or saturated, branched or linear, aliphatic or aromatic alcohols having a total amount of carbon atoms from C6 to C30, from C8 to C22, from C8 to C20, or from C8 to C18 in the alcohol substituent.

It is appreciated that the expression “one or more” phosphoric acid tri-ester means that one or more kinds of phosphoric acid tri-ester may be present on at least a part of the surface of the surface reactive white mineral material-containing particles.

Accordingly, it should be noted that the one or more phosphoric acid tri-ester may be one kind of phosphoric acid tri-ester. Alternatively, the one or more phosphoric acid tri-ester may be a mixture of two or more kinds of phosphoric acid tri-ester. For example, the one or more phosphoric acid tri-ester may be a mixture of two or three kinds of phosphoric acid tri-ester, like two kinds of phosphoric acid tri-ester.

In some embodiments, approximately 1%, at least 0.1%, or at least 1% of the accessible surface area of the calcium carbonate material, such as ground calcium carbonate (GCC) and/or precipitated calcium carbonate (PCC), is covered by a coating comprising stearic acid and/or reaction products thereof.

### Other Ingredients

In some embodiments, the polymer composition of the present invention may optionally or further comprise at least one ingredient (e.g., at least one additive). In certain embodiments, the at least one additives can be added for any suitable purpose including but not limited to, the purpose of increasing impact resistance, melt elasticity, stability and resistance to oxidation of the polymer product. In other embodiments, at least one additive is any suitable ingredient or additive (e.g., to provide one or more desired properties), and in some embodiments can be selected from blowing agents, processing aids, impact modifiers, stabilizers (e.g., heat stabilizers or UV stabilizers), nucleating agents, lubricants, waxes, pigments, colouring agents, plasticizers, thermal modifiers, flame retardants, biocides, smoke suppressors, UV Inhibitors, regrind, recycled scrap, and mixtures thereof. In some embodiments, one or more of the at least one additives can be included in the polymer resin composition, the masterbatch composition, or both.

In some embodiments, the polymer composition further comprises a blowing agent. In other embodiments, the blowing agent can be included in the polymer resin composition, the masterbatch composition, or both. The term “blowing agent” refers to agents which are capable of producing a cellular structure in a polymer product during a foaming process. The blowing agent may be any suitable blowing agent used in foaming of polymers such as organic blowing agents, inorganic blowing agents, physical blowing agents or blowing agents that undergo phase change from liquid to gas during the foaming process. For example, organic blowing agents are selected from the group consisting of azodicarbonamide, diazoaminobenzene, azo-bis-isobutyro-nitrile and analogs thereof.

Inorganic blowing agents are selected from the group consisting of ammonium carbonate, sodium bicarbonate and the like. In other embodiments, physical blowing agents are selected from nitrogen, carbon dioxide and other inert gases. In certain embodiments, blowing agents that undergo phase change from liquid to gas during the foaming process are selected from the group consisting of chlorofluorocarbons (CFC), HFCF, low boiling alcohols, ketones, and hydrocarbons.

In some embodiments, the blowing agent is a thermally decomposable blowing agent. In certain embodiments, the blowing agent is selected such that it decomposes at a temperature of at least 180° C., at least 190° C., or at least 200° C. For example, the blowing agent is selected such that is has a decomposition temperature of from 200° C. to 240° C. The blowing agent may sometimes further comprise one or more additives to reduce its decomposition temperature.

In some embodiments, the blowing agent is azodicarbonamide. For the purpose of the present invention, any azodicarbonamide that decomposes at a temperature higher than a specific temperature and generates gas is suitable for use. In certain embodiments, the azodicarbonamide is selected such that it decomposes at a temperature of at least 180° C., at least 190° C., or at least 200° C. For example, the azodicarbonamide is selected such that is has a decomposition temperature of from 200° C. to 210° C.

In other embodiments, the polymer composition comprises the azodicarbonamide added in powder form, in wax, or in mineral oil.

In some embodiments, the blowing agent can be used in an amount sufficient to produce the desired degree of foaming. In certain embodiments, the polymer composition of the present invention comprises the blowing agent in an amount of less than 1 phr, in an amount of from phr to 0.8 phr, or in an amount of from 0.5 phr to 0.7 phr. For example, the blowing agent can be present in the polymer composition in an amount of 0.6 phr.

In other embodiments, the polymer composition of the present invention comprises the blowing agent in an amount of less than 1 wt %, from 0.3 wt % to 0.75 wt %, and from 0.3 wt % to 0.6 wt %, based on the total weight of the polymer composition. In certain embodiments, the polymer composition of the present invention comprises the blowing agent in an amount of from 0.3 wt % to 0.5 wt %, based on the total weight of the polymer composition. For example, the polymer composition of the present invention comprises the blowing agent in an amount of 0.4 wt % to 0.5 wt %, based on the total weight of the polymer composition. In certain embodiments, the polymer composition of the present invention comprises the blowing agent in an amount of about 0.45 wt %, based on the total weight of the polymer composition. In certain embodiments, a blowing agent is not included in the polymer composition.

Any suitable blowing agents can be used, and some are available from commercial sources. Some examples of useful blowing agents include various azodicarbonamides, such as those available from Cellular Additives, Asheville, USA as Forte-cell.

In some embodiments, the polymer composition of the present invention optionally or further comprises at least one processing aid. The at least one processing aid can be in the polymer resin composition, the masterbatch composition, or both. Processing aids can, in some instances, be employed in the polymer composition to improve melt elasticity and strength and to prevent the collapse of the cellular structure during processing. In other embodiments, the processing aid is selected from low molecular weight acrylic polymers, medium molecular weight acrylic polymers, and/or high molecular weight acrylic polymers. The acrylic polymers can sometimes be acrylic copolymers.

In certain embodiments, the processing aid is an acrylic polymer, the acrylic polymer (e.g., an acrylic copolymer) having a specific gravity from 1.00 g/cm³ to 1.30 g/cm³, from 1.02 g/cm³ to 1.25 g/cm³, or from 1.10 g/cm³ to 1.20 g/cm³. Additionally or alternatively, the acrylic polymer can have a bulk density of at least 0.25 g/cm³, of at least 0.38 g/cm³, or of at least 0.40 g/cm³. “Bulk density” in the meaning of the present invention is a property of powders, granules and other “divided” solids and is defined as the mass of many particles of the material divided by the total volume they occupy. The total volume includes particle volume, inter-particle void volume and internal pore volume.

Additionally or alternatively, the low molecular weight acrylic polymer can have a viscosity of from 10 to 100, from 20 to 80, from 30 to 70, from 40 to 60 cs (©25° C.), from 0.05 Pa·s to 0.30 Pa·s, from 0.08 Pa·s to 0.25 Pa·s or from 0.10 Pa·s to 0.20 Pa·s. Additionally or alternatively, the acrylic polymer can be not more than 2 wt %, not more than 1.5 wt %, or not more than 1 wt % of the polymer composition.

In certain embodiments, the at least one processing aid comprises a mixture of processing aids. In other embodiments, the processing aid comprises a mixture of a low molecular weight acrylic polymer, a medium molecular weight acrylic polymer, and/or a high molecular weight acrylic polymer.

In other embodiments, the at least one processing aid is in the form of a powder.

Any suitable processing aids can be used, and some are available from commercial sources. Some examples of useful processing aids include the processing aids available from Kaneka Texas Corporation, Pasadena, USA (Kane Ace® PA101 Processing aid or Kane Ace® PA40 Processing aid) or from Arkema (e.g., Plastistrength® 530, Plastistrength® 550, Plastistrength® 562, or Plastistrength® 770).

In some embodiments, the polymer composition of the present invention comprises the processing aid in an amount of at least 0.2 phr, from 0.5 phr to 3 phr, or from 0.75 phr to 2.5 phr. For example, the polymer composition comprises the processing aid in an amount of 1 phr.

In other embodiments, the polymer composition comprises the processing aid in an amount of at least 0.1 wt %, from 0.25 wt % to 2.5 wt % or from 0.5 wt % to 2.0 wt %, based on the total weight of the polymer composition. In some embodiments, the polymer composition comprises the processing aid in an amount of from 0. 5 wt % to 1.0 wt %, based on the total weight of the polymer composition.

In some embodiments, the polymer composition of the present invention further comprises an impact modifier (e.g., an acrylic impact modifier). The impact modifier can be in the polymer resin composition, the masterbatch composition, or both. In some embodiments, the acrylic impact modifiers which are used to improve the impact strength of a polymer product may be added to the polymer composition according to the particular circumstance. In other embodiments, the polymer composition comprises the acrylic impact modifier in an amount of at least 1 phr, from 2 phr to 6 phr, or from 3 phr to 5 phr. For example, the polymer composition comprises the acrylic impact modifier in an amount of 4 phr.

Alternatively, the polymer composition comprises the acrylic impact modifier in an amount of at least 1.5 wt %, from 1.5 wt % to 5 wt %, or from 2 wt % to 4 wt %, based on the total weight of the polymer composition. In certain embodiments, the polymer composition comprises the acrylic impact modifier in an amount of from 2.5 wt % to 3.5 wt %, based on the total weight of the polymer composition. For example, the polymer composition comprises the acrylic impact modifier in an amount from 2.75 wt % to 3.25 wt %, based on the total weight of the polymer composition.

Any suitable impact modifier can be used, and some are available from commercial sources. Some examples of useful impact modifiers include acrylic impact modifiers such as those available from Dow Chemical Company, Midland, USA (e.g., Paraloid™ KM 366) or Arkema (e.g., Durastrength 200).

In some embodiments, the polymer composition of the present invention optionally or further comprises a stabilizer. The stabilizer can be in the polymer resin composition, the masterbatch composition, or both. In some embodiments, a stabilizer is in the polymer composition. In other embodiments, a Ca—Zn-containing stabilizer is in the polymer composition. In certain embodiments, the polymer composition comprises the Ca—Zn-containing stabilizer in an amount of at least 1 phr, from 2 phr to about 6 phr, or from 3 phr to 5 phr. For example, the polymer composition comprises the Ca—Zn-containing stabilizer in an amount from 4 phr to 4.5 phr.

Alternatively, the polymer composition comprises the Ca—Zn-containing stabilizer in an amount of at least 2 wt %, from 2 wt % to 5 wt %, or from 2.5 wt % to 5 wt %, based on the total weight of the polymer composition. In certain embodiments, the polymer composition comprises the Ca—Zn-containing stabilizer in an amount of from 2.5 wt % to 4 wt %, based on the total weight of the polymer composition. For example, the polymer composition comprises the Ca—Zn-containing stabilizer in an amount from 3 wt % to 3.5 wt %, based on the total weight of the polymer composition.

Any suitable Ca—Zn-containing stabilizers can be used, and some are available from commercial sources. Some examples of Ca—Zn-containing stabilizers include the Ca—Zn-containing stabilizer available from Inter-Harz GmbH, Elmshorn, Germany as Stabilox CZ 2913 GN.

In other embodiments, the stabilizer may be selected from a variety of organotin stabilizers. For example, methyl tin, butyl tin, reverse ester tins and tin mercaptides may be added to the inventive composition. Such organotin stabilizers comprise several classes of compounds. Tin mercaptide stabilizers (e.g., methyl tin, butyl tin, octyl tin, or combinations thereof) can sometimes comprise blends of dialkyltin bis(iso-thioglycolates) with monoalkyltin tris(iso-thioglycolates). Tin mercaptide stabilizers (e.g., methyl tin, butyl tin, octyl tin, or combinations thereof) and/or reverse ester tin stabilizers can sometimes comprise blends of dialkyltin bis(2-mercaptoethyl oleates). Other organotin stabilizers which may sometimes be added to the inventive composition comprise dialkytin carboxylateesters, of which the most common are dialkytin maleate esters such as dialkyltin maleate octoate.

If an organotin stabilizer is added to the inventive polymer composition, said polymer composition can, in certain embodiments, comprise the organotin stabilizer in an amount of at least phr, from 0.1 phr to 3.0 phr, from 0.1 phr to 3.5 phr or from 0.25 phr to 1.5 phr. In certain embodiments, the polymer composition comprises the organotin stabilizer in an amount from 0.25 phr to 1.25 phr, from 0.25 phr to 2.5 phr or from 0.25 phr to 3.0 phr.

In other embodiments, the polymer composition comprises the organotin stabilizer in an amount of at least 0.1 wt %, from 0.1 wt % to 2.5 wt % or from 0.1 wt % to 2 wt %, based on the total weight of the polymer composition. In certain embodiments, the polymer composition comprises the organotin stabilizer in an amount from 0.1 wt % to 2 wt %, based on the total weight of the polymer composition. For example, the polymer composition comprises the organotin stabilizer in an amount from 0.1 wt % to 1.75 wt %, based on the total weight of the polymer composition.

Any suitable organotin stabilizer can be used, and some are available from commercial sources. Some examples of organotin stabilizer include organotin stabilizers available from PMC Organometallix (e.g., ADVASTAB TM-697 or ADVASTAB TM-181 FS).

In some embodiments, the polymer composition of the present invention optionally or further comprises a nucleating agent. The nucleating agent can be in the polymer resin composition, the masterbatch composition, or both. In certain embodiments, a nucleating agent is in the polymer composition. Sometimes, the nucleating agent can be selected such that the formation of bubbles for foaming is promoted. In other embodiments, the nucleating agent does not support crystallization. The bubble-promoting nucleating agents can optionally be included in the polymer composition. Such bubble-promoting nucleating agents can be selected from the variety of inert solids disclosed in the prior art to be useful as such nucleating agents, including mixtures of citric acid and sodium bicarbonate or other alkali metal bicarbonates, talc, silicon oxide, diatomaceous earth, kaolin, polycarboxylic acids and their salts, and titanium dioxide. Other inert solids disclosed in the art for these purposes may also be found suitable.

In some embodiments, the polymer composition comprises the nucleating agent in an amount of at least 1 phr, from 2 phr to about 6 phr, or from 3 phr to 5 phr. For example, the polymer composition comprises the nucleating in an amount from 4 phr to 4.5 phr.

Alternatively, the polymer composition comprises the nucleating agent in an amount of at least 2 wt %, from 2 wt % to 5 wt %, or from 2.5 wt % to 5 wt %, based on the total weight of the polymer composition. In certain embodiments, the polymer composition comprises the nucleating agent in an amount from 2.5 wt % to 4 wt %, based on the total weight of the polymer composition. For example, the polymer composition comprises the nucleating agent in an amount from 3 wt % to 3.5 wt %, based on the total weight of the polymer composition. Additionally or alternatively, further additives such as lubricants (e.g., waxes, oxidized

polyethylene waxes, polyethylenes (such as any of those described herein) etc.), calcium stearates (e.g., which can act as a stabilizer and/or lubricant), colouring agents, pigments (e.g., titanium dioxides) and/or plasticizers can be included in the polymer resin composition, the masterbatch composition, or both. In some embodiments, such further additives can be present in the polymer composition of at least 0.25 phr, from 0.5 phr to 2 phr, or from 1 phr to 1.5 phr. In other embodiments, the polymer composition can comprise these further additives in an amount of 1.35 phr. In certain embodiments, the further additives comprise a mixture of a lubricant of 0.10 phr, calcium stearate of 1.5 phr and titanium dioxide of 1 phr.

In certain embodiments, the polymer composition can comprise further additives, such as lubricants (e.g., waxes, oxidized polyethylene waxes, polyethylene (such as any of those described herein), etc.), calcium stearates (e.g., which can act as a stabilizer and/or lubricant), colouring agents, pigments (e.g., titanium dioxides) and/or plasticizers in an amount for each additive of at least 0.01 wt %, at least 0.05 wt %, from 0.05 wt % to 5 wt %, or from 0.05 wt % to 3 wt %, based on the total weight of the polymer composition. Any suitable lubricants (e.g., waxes, oxidized polyethylene waxes, polyethylene (such

as any of those described herein), etc.), calcium stearates (e.g., which can act as a stabilizer and/or lubricant), colouring agents, pigments (e.g., titanium dioxides) and/or plasticizers can be used and some are available from a variety of commercial sources. In some embodiments, lubricants include the lubricant available from Reagens Deutschland GmbH (e.g., Realube® 3010) or Honeywell (e.g., A-C 629 oxidized polyethylene or Rheolub® XL-165R as paraffin wax or Rheolub® XL-165-010). In other embodiments, calcium stearates include the calcium stearate available from Reagens Deutschland GmbH (e.g., Realube AIS) or PMC Organometallics (e.g., ADVASTAB TM-697 or ADVASTAB TM-181 FS). In certain embodiments, titanium dioxides include the titanium dioxide available from the Chemours company (e.g., Ti-Pure R-960). In some embodiments, plasticizers can include epoxidized soybean oil (e.g., Vikoflex 7170 from Arkema/Cargill). In certain embodiments, the polymer composition does not include a plasticizer.

### Polymer Resin Composition

The term “polymer resin composition” refers to a composition having certain components; each component of the polymer resin composition can be the same as or different from the components (e.g., ingredients or additives) found in the masterbatch composition. In some embodiments, the polymer composition comprises (e.g., consists of) the polymer resin composition and the masterbatch composition.

In other embodiments, the polymer resin composition comprises at least one halogenated polymer resin of 50 wt %, 51 wt %, 52 wt %, 53 wt %, 54 wt %, 55 wt %, 56 wt %, 57 wt %, 58 wt %, 59 wt %, 60 wt %, 65 wt %, 70 wt %, 75 wt %, 80 wt %, 85 wt %, 86 wt %, 87 wt %, 88 wt %, 89 wt %, wt %, at least 50 wt %, from 50 wt % to 90 wt %, from 55 wt % to 85 wt %, from 60 wt % to 85 wt %, or from 65 wt % to 80 wt % based on the total weight of the polymer resin composition. In some embodiments, the polymer resin composition comprises a first calcium carbonate material of 0.1 wt %, wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt'Yo, 14 wt'Yo, 15 wt'Yo, 16 wt'Yo, 17 wt'Yo, 18 wt'Yo, 19 wt'Yo, 20 wt'Yo, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, no more than 34 wt %, from 0.1 to 34 wt %, from 0.5 to 34 wt %, from 1 to 34 wt %, from 5 to 34 wt %, from 0.1 to wt %, from 0.5 to 25 wt %, from 1 to 25 wt %, from 5 to 25 wt %, from 10 to 20 wt %, from 10 to 18 wt %, or from 12 to 16 wt %, based on the total weight of the polymer resin composition. In certain embodiments, the polymer resin composition can comprise any other

suitable additional ingredients, such as but not limited to those described herein (e.g., in the “Other Ingredients” section), at any suitable concentration such as but not limited to those described herein to provide a desired concentration in the polymer composition (e.g., in the “Other Ingredients” section).

Masterbatch Composition

The term “masterbatch composition” refers to a composition having certain components; each component of the masterbatch composition can be the same as or different from the components (e.g., ingredients or additives) found in the polymer resin composition. In some embodiments, the polymer composition comprises (e.g., consists of) the polymer resin composition and the masterbatch composition.

In some embodiments, the masterbatch composition comprises a second calcium carbonate material at 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, 99.5 wt %, 99.7 wt %, 99.9 wt %, from 50 to 99.9 wt %, from 60 to 95 wt %, from 70 to 90 wt %, or from 70 to 85 wt %, based on the total weight of the masterbatch composition. In certain embodiments, the masterbatch composition comprises at least one masterbatch polyethylene, at least one masterbatch polypropylene, or both. In other embodiments, the masterbatch composition comprises at least one masterbatch polyethylene at 0.1 wt %, 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt'Yo, 14 wt'Yo, 15 wt'Yo, 16 wt'Yo, 17 wt'Yo, 18 wt'Yo, 19 wt'Yo, 20 wt'Yo, 21 wt'Yo, 22 wt'Yo, 23 wt'Yo, 24 wt %, 25 wt %, 26 wt %, 27 wt %, 28 wt %, 29 wt %, 30 wt %, no more than 30 wt %, from 0.1 wt % to 30 wt %, from 1 wt % to 30 wt %, from 5 wt % to 25 wt %, from 15 wt % to 25 wt %, from 20 wt % to 25 wt %, from 7.5 wt % to 20 wt %, or from 9 wt % to 15 wt %, based on the total weight of the masterbatch composition. In certain embodiments, the masterbatch composition comprises at least one masterbatch polypropylene at 0.1 wt %, 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, no more than 30 wt %, from 0.1 wt % to 30 wt %, from 1 wt % to 30 wt %, from 5 wt % to 25 wt %, from 15 wt % to 25 wt %, from 20 wt % to 25 wt %, from 7.5 wt % to 20 wt %, or from 9 wt % to 15 wt %, based on the total weight of the masterbatch composition.

In certain embodiments, the masterbatch composition can comprise any other suitable additional ingredients, such as but not limited to those described herein (e.g., in the “Other Ingredients” section), at any suitable concentration such as but not limited to those described herein to provide a desired concentration in the polymer composition (e.g., in the “Other Ingredients” section).

For example, additional ingredients can include processing aids and/or oxidized polyethylene wax which can be at no more than 20 wt %, from 1 wt % to 20 wt %, from 2 wt % to 20 wt %, from 5 wt % to 15 wt %, or from 7 wt % to 12 wt %, based on the total weight of the masterbatch composition.

In some embodiments, the masterbatch composition consists essentially of at least one masterbatch polyethylene, at least one masterbatch polypropylene, or both, such that the fusion time of the polymer composition is less than (A) the fusion time of a composition consisting of (1) the polymer resin composition and (2) the second calcium carbonate material, or (B) the fusion time of the polymer resin composition, where the fusion time is measured according to ASTM D2538-18. In some embodiments, the masterbatch composition consists of at least one masterbatch polyethylene, at least one masterbatch polypropylene, or both. In other embodiments, the masterbatch composition consists of at least one masterbatch polyethylene. In some embodiments, the masterbatch composition consists of at least one masterbatch polypropylene.

In certain embodiments, the masterbatch composition does not comprise a process aid. In other embodiments, the masterbatch composition does not comprise oxidized polyethylene wax. In still other embodiments, the masterbatch composition does not comprise a stabilizer. In yet other embodiments, the masterbatch composition does not comprise an impact modifier. In other embodiments, the masterbatch composition does not comprise a blowing agent. In other embodiments, the masterbatch composition does not comprise a nucleating agent. In other embodiments, the masterbatch composition does not comprise a wax. In other embodiments, the masterbatch composition does not comprise a pigment. In other embodiments, the masterbatch composition does not comprise one or more of colouring agent, plasticizer, thermal modifier, flame retardant, biocide, smoke suppressor, and/or additional lubricant (e.g., that is not a polyethylene or not a polypropylene). In certain embodiments, the masterbatch composition does not comprise a halogenated polymer resin. In other embodiments, the masterbatch composition does not include PVC. In still other embodiments, the masterbatch composition does not include post-chlorinated vinyl polychloride (PVCC). In yet other embodiments, the masterbatch composition does not include polyvinylidene fluoride (PVDF).

The masterbatch composition may then be combined with the polymer resin composition in a sufficient amount to form the polymer composition. For example, the masterbatch composition can be added to the polymer resin composition or the polymer resin composition can be added to the masterbatch composition. In some embodiments, the masterbatch composition can be at wt %, 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt'Yo, no more than 20 wt'Yo, from 0.1 wt % to 20 wt %, from 1 wt % to 20 wt %, from 2 wt % to 20 wt %, from 5 wt % to 15 wt %, or from 7 wt % to 12 wt %, based on the total weight of the polymer composition. In certain embodiments, the polymer resin composition can be at 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, 99.5 wt %, 99.7 wt %, 99.9 wt %, no less than 80 wt %, from 80 wt % to 99.9 wt %, from 80 wt % to 99 wt %, from 80 wt % to 98 wt %, from 85 wt % to 95 wt %, or from 88 wt % to 93 wt %, based on the total weight of the polymer composition.

### Method for Decreasing Fusion Time

In some embodiments, a method for decreasing fusion time is provided, comprising a) providing a polymer resin composition comprising at least one halogenated polymer resin and a first calcium carbonate material, b) providing a masterbatch composition comprising (i) a second calcium carbonate material and (ii) at least one masterbatch polyethylene, at least one masterbatch polypropylene, or both, and c) contacting the polymer resin composition with the masterbatch composition to provide a polymer composition. In other embodiments, the at least one halogenated polymer resin is at least 50 wt % of the polymer composition. In still other embodiments, the first calcium carbonate material is no more than 34 wt % of the polymer composition. In yet other embodiments, the second calcium carbonate material is from 1 to 35 wt % of the polymer composition. In certain embodiments, the total calcium carbonate material in the polymer composition is from 17 to 35 wt % of the polymer composition. In some embodiments, the fusion time of the polymer composition is less than (A) the fusion time of a composition consisting of (1) the polymer resin composition and (2) the second calcium carbonate material, or (B) the fusion time of the polymer resin composition, where the fusion time is measured according to ASTM D2538-18.

In some embodiments, components of the polymer composition (e.g., the masterbatch composition and the polymer resin composition) described herein can be contacted using any suitable technique including but not limited to conventional high shear mixing techniques, conventional low shear mixing techniques, an extruder, a Haake twin screw extruder with a counter-rotating screw configuration, a Leistritz Twin Screw extruder, or a CM-35 conical twin screw extruder. The contacting time and contacting temperature can be any suitable time and temperature, including but not limited to those disclosed herein.

### Method for Making Polymer Product and the Polymer Product

In some embodiments, a method for preparing a polymer product is provided, comprising the following steps: providing the polymer composition, and subjecting the polymer composition to conditions under which the polymer composition is converted into a polymer product.

Appropriate process conditions for polymer products (e.g., rigid polymer products) are commonly known to the skilled person and/or can be established by routine modifications based on common general knowledge.

In some embodiments, components of the polymer composition (e.g., the masterbatch composition and the polymer resin composition) described herein can be blended using any suitable technique including but not limited to conventional high shear mixing techniques or conventional low shear mixing techniques.

After the components of the polymer composition have been blended (e.g., by conventional high shear mixing techniques or by conventional low shear mixing techniques), the polymer composition can, in certain embodiments, be converted into a polymer product by any suitable technique, including but not limited to conventional processing techniques such as blow molding, injection molding, compression molding or extrusion molding.

In certain embodiments, the polymer composition of the present invention is processed in a conventional extruder which has been fitted with the desired die and which extruder has been heated to the desired temperature. The extruder can be operated at a screw speed, temperatures and residence times such that polymer product (e.g., rigid polymer products) are formed which are commercially acceptable.

For example, the polymer composition may be processed in a Haake twin screw extruder with a counter-rotating screw configuration, a Leistritz Twin Screw extruder, or a CM-35 conical twin screw extruder.

In certain embodiments, a polymer product is prepared from the polymer composition disclosed herein. In other embodiments, the polymer product is a rigid polymer product. In certain embodiments, the polymer product is a pipe, tubing, siding, window profile, roller-blind profile, sheet, sign, tile, fencing, decking, gutters, credit card stock, blister pack, UL conduit, foam board, foam trim, ceiling tile, and vinyl record.

In some embodiments, a polymer product has a density below 1.33 g/cm³ or from 0.5 g/cm³ to 1.33 g/cm³. For example, the obtained polymer product can have a density below 1.33 g/cm³, below 1 g/cm³, below 0.8 g/cm³, below 0.75 g/cm³, or below 0.73 g/cm³ (e.g., for example from 0.5 to g/cm³ or 0.71 g/cm 3).

In some embodiments, the polymer product prepared from the polymer composition can have an impact strength (measured using ASTM D4226 on extruded samples) from 30 to 150 inch lbs, from 40 to 100 inch lbs, or from 50 to 80 inch lbs.

In some embodiments, the polymer product prepared from the polymer composition can have a Durometer Hardness of 20 A, 25 A, 30 A, 35 A, 40 A, 45 A, 50 A, 55 A, 60 A, 65 A, 70 A, A, 80 A, 85 A, 90 A, 95 A, 100 A, 105 A, 110 A, 115 A, 120 A, 125 A, 130 A, 135 A, 140 A, 145 A, 150 A, 160 A, 170 A, 180 A, 190 A, 200 A, at least 20 A, at least 50 A, from 50 A to 100 A, from 60 A to 100 A, from 70 A to 100 A, from 80 A to 100 A, or from 90 A to 100 A, measured using ASTM D2240 with a A scale Durometer.

In some embodiments, the polymer product prepared from the polymer composition can have a Durometer Hardness of 20 D, 25 D, 30 D, 35 D, 40 D, 45 D, 50 D, 55 D, 60 D, 65 D, 70 D, D, 80 D, 85 D, 90 D, 95 D, 100 D, 105 D, 110 D, 115 D, 120 D, 125 D, 130 D, 135 D, 140 D, 145 D, 150 D, 160 D, 170 D, 180 D, 190 D, 200 D, at least 20 D, at least 30 D, at least 40 D, at least 50 D, from 20 D to 100 D, from 30 D to 100 D, from 40 D to 100 D, from 50 D to 100 D, from 60 D to 100 D, from 70 D to 100 D, from 80 D to 100 D, or from 90 D to 100 D, measured using ASTM D2240 with a D scale Durometer.

The presently disclosed subject matter is further illustrated by the following specific but non-limiting examples. The following examples may include compilations of data that are representative of data gathered at various times during the course of development and experimentation related to the present invention.

### EXAMPLES

### Example Set A—Polymer Compositions Comprising PVC and Masterbatches

The following methods were used in this example set, unless otherwise noted. The Dart Drop Impact Measurements were performed according to ASTM D4226. The Color Measurement was performed accordingly to ASTM E308. The Gloss Measurement was performed according to ASTM D523.

Ash Content is determined by heating a sample in a crucible which is put into a furnace at 600° C. for 24 h. The ash content was measured as the total amount of remaining inorganic residues.

Three different initial PVC masterbatches were prepared using a Leistritz twin screw extruder. Table Al shows the formulations for the three masterbatches.

TABLE A1
Example Masterbatch Formulations

| | MB-A | | MB-B | | MB-C | |
|---|---|---|---|---|---|---|
| | PHR | wt % | PHR | wt % | PHR | wt % |
| CaCO₃—C | 12.000 | 80.00 | 9.83 | 76.62 | 7.77 | 72.15 |
| Polyethylene | 1.500 | 10.00 | 1.50 | 11.69 | 1.50 | 13.93 |
| Process Aid | 1.500 | 10.00 | 0.00 | 0.00 | 0.75 | 6.96 |
| Oxidized | 0.000 | 0.00 | 1.50 | 11.69 | 0.75 | 6.96 |
| Polyethylene | | | | | | |
| Wax | | | | | | |
| Total | 15 | 100.00 | 12.83 | 100.00 | 10.77 | 100.00 |

The following commercially available components were used for preparing the masterbatches:

CaCO₃—C is a commercially available product of calcium carbonate particles (from Omya International AG). The calcium carbonate is a wet ground GCC, treated with 1% by weight stearic acid. The calcium carbonate particles have the following properties: d₅₀ before stearic acid treatment is 1.4 μm, d₉₈ before stearic acid treatment is 6.0 μm and the BET surface area is approximately 5.5 m²/g.

The polyethylene is commercially available as Marlex® 1017 Polyethylene (from Chevron Phillips Chemical Company). The polyethylene is a low density polyethylene. This polyethylene has the following properties: the melt index (190° C./2.16 kg) is approximately 7 g/10 min (measured using the ASTM D1238 method), the density is approximately 0.917 g/cm³ (measured using the ASTM D1505 method), the Vicat softening temperature is approximately 90° C. (measured using ASTM D1525), and the melting point is approximately 104° C. (measured using ASTM D3418).

The process aid is commercially available as Plastistrength ® 566 (from Arkema). It is an ultra high molecular weight acrylic process aid. It has a specific gravity of approximately 1.11 and a bulk density of approximately 0.5 g/cm³.

The oxidized polyethylene wax is commercially available from Westlake Chemical Corp. as E-20 Ox-PE, emulsifiable — oxidized low molecular weight Epolene® polymer. It has an Mw molecular weight of approximately 5,560 and an Mn molecular weight of approximately 1,295. It has a density (at 25° C.) of approximately 0.960 g/cm³, as measured using ASTM method D-5. It has a Brookfield Thermosel Viscosity of approximately 1,500 cP (at 125° C.) and approximately 900 cP (at 140° C.), as measured using ASTM method D-3226.

The Table A1 masterbatches were hand mixed with the PVC substrate formulation (as shown in Table A2 below) to make the PVC Formulations. After hand mixing, the PVC formulations were then extruded on a CM-35 twin screw lab extruder.

TABLE A2
Example PVC Formulations

| | PVC substrate | | PVC substrate | | PVC substrate | |
|---|---|---|---|---|---|---|
| | formulation plus MB- | | formulation plus MB- | | formulation plus MB- | |
| | A | | B | | C | |
| | Pounds | wt % | Pounds | wt % | Pounds | wt % |
| PVC Substrate | 22.40 | 89.61 | 22.75 | 90.99 | 23.08 | 92.31 |
| Formulation | | | | | | |
| Masterbatch from | 2.60 | 10.39 | 2.25 | 9.01 | 1.92 | 7.69 |
| Table A1 | | | | | | |
| Total | 25.00 | 100.00 | 25.00 | 100.00 | 25.00 | 100.00 |

Table A3 provides the ingredients of the formulations. The “Total CaCO₃” in each formulation below is based upon the ash values measured from the extruded sheets.

TABLE A3
Example PVC Formulations

| | PVC substrate | | PVC substrate | | PVC substrate | | PVC substrate | |
|---|---|---|---|---|---|---|---|---|
| | formulation only | | formulation plus | | formulation plus | | formulation plus | |
| | (control) | | MB-A | | MB-B | | MB-C | |
| | PHR | wt % | PHR | wt % | PHR | wt % | PHR | wt % |
| PVC Resin | 100.00 | 77.28 | 100.00 | 69.25 | 100.00 | 70.31 | 100.00 | 71.34 |
| Stabilizer | 1.00 | 0.77 | 1.00 | 0.69 | 1.00 | 0.7 | 1.00 | 0.71 |
| Process Aid | 1.00 | 0.77 | 1.00 | 0.69 | 1.00 | 0.7 | 1.00 | 0.71 |
| Impact Modifier | 4.00 | 3.09 | 4.00 | 2.77 | 4.00 | 2.81 | 4.00 | 2.85 |
| Calcium | 1.50 | 1.16 | 1.50 | 1.04 | 1.50 | 1.05 | 1.50 | 1.07 |
| Stearate | | | | | | | | |
| Paraffin Wax | 0.80 | 0.62 | 0.80 | 0.55 | 0.80 | 0.56 | 0.80 | 0.57 |
| Oxidized | 0.10 | 0.08 | 0.10 | 0.07 | 0.10 | 0.07 | 0.10 | 0.07 |
| Polyethylene | | | | | | | | |
| CaCO₃-A | 20.00 | 15.46 | 20.00 | 13.85 | 20.00 | 14.06 | 20.00 | 14.27 |
| TiO₂ | 1.00 | 0.77 | 1.00 | 0.69 | 1.00 | 0.70 | 1.00 | 0.71 |

Masterbatch contributions

| | | | | | | | | |
|---|---|---|---|---|---|---|---|---|
| CaCO₃—C | 0 | 0 | 12.000 | 8.31 | 9.83 | 6.91 | 7.77 | 5.54 |
| Polyethylene | 0 | 0 | 1.500 | 1.04 | 1.50 | 1.05 | 1.50 | 1.07 |
| Process Aid | 0 | 0 | 1.500 | 1.04 | 0.00 | 0.00 | 0.75 | 0.54 |
| Oxidized | 0 | 0 | 0.00 | 0.00 | 1.50 | 1.05 | 0.75 | 0.54 |
| Polyethylene | | | | | | | | |
| Wax | | | | | | | | |

Totals and Ash content

| Totals | 129.40 | 100.00 | 144.40 | 100.00 | 142.23 | 100.00 | 140.17 | 100.00 |
|---|---|---|---|---|---|---|---|---|
| Total | 20.00 | 15.46 | 32.000 | 22.16 | 29.830 | 20.97 | 27.770 | 19.81 |
| expected | | | | | | | | |
| CaCO₃ | | | | | | | | |
| Ash content | 16.91ª | | 22.11 | | 20.97 | | 19.82 | |
| measured from | | | | | | | | |
| extruded sheet | | | | | | | | |

^{a}Ash content averaged from two batches (17.19% and 16.63%)

The following commercially available components were used for preparing the PVC substrate formulation:

The PVC resin is commercially available as PVC-1091 (from Westlake Chemical, Houston, Tex. USA). The PVC resin is a medium molecular weight resin. It has an inherent viscosity and relative viscosity (PPVC 45A) of approximately 0.90±0.02 and approximately 2.13, respectively. It has a K value (DIN 53726) of approximately 65. The bulk density (PPVC 24) is approximately >33.7 lbs/ft³ or approximately >0.540 gms/cm³.

The stabilizer is commercially available as ADVASTAB™ TM-697 (from PMC Organometallix, Inc.). It has a specific gravity of approximately 1.04@ 25° C.), a weight of approximately 8.6 lb/gal@ 25° C.), a viscosity of approximately 56 cs@25° C.), approximately 10.5% of Sn, and approximately 10.5% of mercaptan sulfur.

The process aid is commercially available as Plastistrength® 550 (from Arkema). It is a medium molecular weight acrylic process aid. It has a specific gravity of approximately 1.17, a bulk density of approximately 0.45 g/cc, and a particle size of approximately 2% max on 40 mesh.

The impact modifier is commercially available as Durastrength® 200 (from Arkema). It is an acrylic impact modifier. It has a specific gravity of approximately 1.13, a bulk density of approximately 0.48 g/cc, and a particle size of approximately 10% max on 50 mesh.

The calcium stearate is commercially available as COAD® 1OLD CALCIUM STEARATE (from NORAC). It meets the requirements of PPI-TR3 and NSF Standard 14 for potable water. It has total ash (as CaO %) of approximately 10.3%, a moisture of approximately 2.0%, free fatty acid of approximately 0.2%, a softening point of approximately 155° C., approximately 97.0% through at 20 mesh, and approximately 20% through at 140 mesh.

The paraffin wax is commercially available as Rheolub® XL-165-010 (from Honeywell). It has a viscosity (@ 210° C.) of approximately 155.

The oxidized polyethylene is commercially available as A-C® 629 (from Honeywell). It is a low density oxidized polyethylene homopolymer. It has a hardness of approximately 5.5, a viscosity (@ 140° C.) of approximately 200, a drop point (Mettler) of approximately 101° C. (214° F.), a density of approximately 0.93, and an acid number of approximately 15.

CaCO₃-A is a commercially available product of calcium carbonate particles (from Omya International AG). The calcium carbonate is a wet ground and treated with 1% by weight stearic acid. The calcium carbonate particles have the following properties: d₅₀ before stearic acid treatment is 0.7 μm, d₉₈ before stearic acid treatment is 5.0 μm and the BET surface area is 9.5 m²/g.

The TiO₂ is commercially available as Ti-Pure R-960 (The Chemours Company). It has a minimum of approximately 89 wt %. Alumina has a maximum of approximately 3.5 wt %. Amorphous silica has a maximum of approximately 6.5 wt %. It has a specific gravity of approximately 3.9.

Prior to extruding the sheet on the CM-35, melt rheology testing was used to determine how the PVC substrate formulations with the three masterbatches performed compared to the PVC substrate formulation without any masterbatch addition.

Two different rheology tests were run to determine the fusion time, equilibrium torque, and several other parameters of the formulations. The first rheology test was run using 100 cc charge at 180° C. at 40 RPM's; this is a low shear test designed to replicate extruders that have water filled screws. The second rheology test was run using 100 cc charge at 180° C. at 80 RPM's; this is a higher shear rate designed to replicate extruders using oil filled screws. This second rheology test also determines the thermal stability of the various formulations. Table A4 shows the rheology test results for the low shear testing.

TABLE A4
Melt Rheology Data
(Brabender 100 cc, 40 rpm, 180° C.)

| | PVC substrate | PVC substrate | PVC substrate | PVC substrate |
|---|---|---|---|---|
| | formulation only | formulation plus | formulation plus | formulation plus |
| | (control) | MB-A | MB-B | MB-C |
| Sample weight of | 64.0 | 67.0 | 68.0 | 67.0 |
| 100 cc (grams) | | | | |
| Load Peak (mg) | 902 | 250 | 550 | 611 |
| Fusion Time¹ | 3:52 | 2:12 | 1:06 | 1:18 |
| (minutes:seconds) | | | | |
| Fusion Torque (mg) | 2,343 | 2,560 | 3,089 | 2,594 |
| Fusion Temp. (° C.) | 182 | 168 | 168 | 163 |
| Final Torque (mg) | 1,591 | 1,618 | 1,858 | 1,567 |
| End Temp. (° C.) | 193 | 183 | 190 | 181 |

All PVC formulations that included masterbatches fused faster than the control (i.e., PVC substrate formulation without masterbatch addition). The fusion torques were higher for the PVC formulations that included masterbatches as well. The fusion temperatures were lower for the PVC formulations that included masterbatches compared to the control.

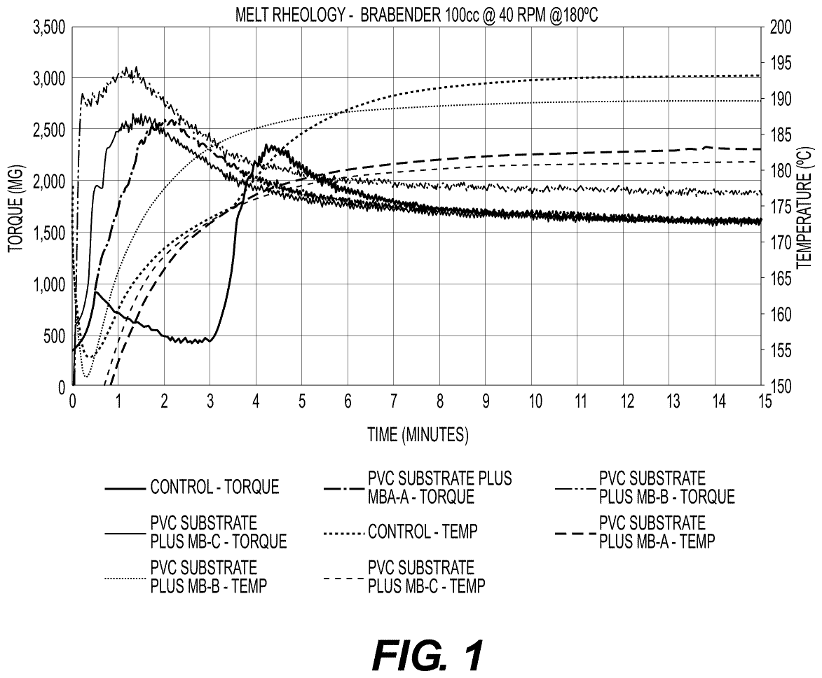

FIG. 1 shows the low shear melt rheology data graphed.

TABLE A5
High Sheer Melt Rheology Data
(Brabender 100 cc, 80 rpm, 180° C.)

| | PVC substrate | PVC substrate | PVC substrate | PVC substrate |
|---|---|---|---|---|
| | formulation only | formulation plus | formulation plus | formulation plus |
| | (control) | MB-A | MB-B | MB-C |
| Sample weight of | 64.0 | 67.0 | 68.0 | 67.0 |
| 100 cc (grams) | | | | |
| Load Peak (mg) | 261 | 553 | 357 | 605 |
| Fusion Time^{a} | 5:40 | 1:16 | 0:58 | 1:00 |
| (minutes:seconds) | | | | |
| Fusion Torque (mg) | 2,266 | 2,765 | 2,516 | 2,657 |
| Fusion Temp. (° C.) | 172 | 176 | 168 | 173 |
| Thermal Stability^{b} | 20:52 | 20:08 | 21:10 | 20:28 |
| (minutes:seconds) | | | | |
| Final Torque (mg) | 1,662 | 1,681 | 1,631 | 1,677 |
| End Temp. (° C.) | 189 | 205 | 199 | 204 |

^{a}Fusion time is the time from the loading peak to the point of maximum torque (as defined by ASTMD2538-18).
^{b}Thermal stability is measured from the time the material is added to the Brabender until the torque rises ~200-meter grams above the equilibrium torque. Also, the process temperature begins to rise steadily.

As seen in Table A5, all three PVC formulations that included masterbatches fused faster and had higher torques than the control. The fusion temperatures are somewhat similar for all the formulations. The thermal stability is relatively the same for all formulations. The PVC formulations that included masterbatches ran hotter than the control.

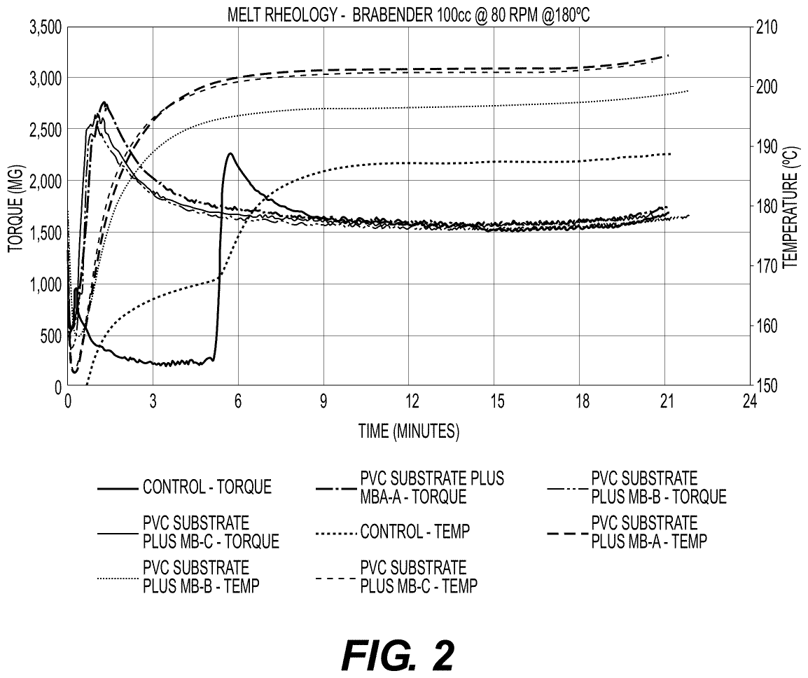

FIG. 2 shows the high shear melt rheology data graphed.

As an example, four PVC formulations were extruded to make vinyl siding. The control formulation was extruded twice, at the beginning of the test to establish the conditions and also at the end to confirm the initial run conditions. Table A6 shows the extruder run conditions for all the formulations in this vinyl siding example.

TABLE A6
Extrudera Run Conditions-Vinyl Siding Example

| | PVC substrate | | PVC substrate | | PVC substrate | | PVC substrate | | PVC substrate | |
|---|---|---|---|---|---|---|---|---|---|---|
| | formulation | | formulation | | formulation | | formulation | | formulation | |
| | only (control) | | plus MB-A | | plus MB-B | | plus MB-C | | only (control) | |
| | Set | Actual | Set | Actual | Set | Actual | Set | Actual | Set | Actual |
| Barrel Zone 1 | 185 | 184 | 185 | 185 | 185 | 184 | 185 | 186 | 185 | 185 |
| (° C.) | | | | | | | | | | |
| Barrel Zone 2 | 180 | 180 | 180 | 180 | 180 | 180 | 180 | 180 | 180 | 180 |
| (° C.) | | | | | | | | | | |
| Barrel Zone 3 | 170 | 170 | 170 | 170 | 170 | 171 | 170 | 170 | 170 | 168 |
| Die Zone 4 (° C.) | 185 | 185 | 185 | 185 | 185 | 185 | 185 | 185 | 185 | 185 |
| Die Zone 5 (° C.) | 185 | 186 | 185 | 185 | 185 | 185 | 185 | 185 | 185 | 185 |
| Die Zone 6 (° C.) | 185 | 185 | 185 | 185 | 185 | 187 | 185 | 186 | 185 | 186 |
| Die Zone 7 (° C.) | 185 | 188 | 185 | 185 | 185 | 185 | 185 | 185 | 185 | 185 |
| Screw Oil (° C.) | 175 | 175 | 175 | 175 | 175 | 175 | 175 | 175 | 175 | 175 |
| Extruder Speed | 16 | 16 | | 16 | | 16 | | 16 | | 16 |
| (rpm) | | | | | | | | | | |
| Feeder speed | 10 | 9.9 | | 9.9 | | 8.9 | | 8.9 | | 9.9 |
| (rpm) | | | | | | | | | | |
| Melt Temp (° C.) | | 183 | | 183 | | 183 | | 183 | | 183 |
| Extruder | | 2350 | | 2600 | | 2360 | | 2400 | | 2300 |
| Pressure (psi) | | | | | | | | | | |
| Extruder | | 49 | | 66 | | 82 | | 83 | | 50 |
| Torque (%) | | | | | | | | | | |
| Output, | | 411 | | 459 | | 410 | | 410 | | 410 |
| (grams/min.) | | | | | | | | | | |
| Output | | 54.317 | | 60.66 | | 54.18 | | 54.18 | | 54.18 |
| (lbs/hour) | | | | | | | | | | |
| Thickness | 0.45 | 0.41- | | 0.41- | | 0.46 | | 0.43 | | 0.46 |
| (inches) | | 0.45 | | 0.42 | | | | | | |
| Speed/distance | | 30/8 | | 30/8 | | 22/8 | | 22/8 | | 29/8 |
| (speed | | | | | | | | | | |
| setting/inches)^{b} | | | | | | | | | | |
| Chiller Temp. | | 20.8 | | | | 29.0 | | 28 | | 27 |
| (° C.) | | | | | | | | | | |

^{a}Extruder: CM-35, conical twin screw; Screw type: oil filled conical
^{b}The Speed is the setting for the puller used to pull the PVC sheet from the extruder through the roll stack. The distance (in inches) is from the end of the extruder to the roll stack. This allows the sheet to set-up and air cool before entering the roll stack to be compressed and cooled

TABLE A7
Dart Drop Impact Data of the Vinyl Siding Example

| | PVC | PVC | PVC | PVC |
|---|---|---|---|---|
| | substrate | substrate | substrate | substrate |
| | formulation | formulation | formulation | formulation |
| | only | plus | plus | plus |
| | (control) | MB-A | MB-B | MB-C |
| MFE (inch lbs) | 101.35 | 34.3 | 73.2 | 64.6 |
| MFE (standard | 15.9 | 12.8 | 11.9 | 8.6 |
| deviation) | | | | |

TABLE A8
Color and Gloss Data of the Vinyl Siding Example

| | PVC | PVC | PVC | PVC |
|---|---|---|---|---|
| | substrate | substrate | substrate | substrate |
| | formulation | formulation | formulation | formulation |
| | only | plus | plus | plus |
| | (control) | MB-A | MB-B | MB-C |
| Color-L | 92.06 | 91.36 | 91.11 | 91.2 |
| Color-b | 3.34 | 3.72 | 4.07 | 3.93 |
| Gloss 75° | 44.35 | 43.5 | 37.1 | 45.2 |

### Results and Discussion

All three of the masterbatches were incorporated into the PVC substrate formulation to increase the CaCO₃ loading. Without the masterbatch additions, the PVC substrate formulation has 17% CaCO₃ or 20-PHR of CaCO₃. The addition of masterbatch-A had the largest increase in CaCO₃ amount, to 22.11%. The addition of masterbatch-B increased the CaCO₃ amount to 20.97%. The addition of masterbatch-C increased the CaCO₃ amount to 19.82%.

Table A7 shows the results of the dart drop impact measurements of the siding extruded from the formulations. The minimum impact standard for vinyl siding is 60 in/lbs (see ASTM D4226 standard). The control formulation had an impact value of about 101 inch-lbs. The formulation with masterbatch-A had an impact value of about 34 inch-lbs. The formulation with masterbatch-B had an impact value of about 73 inch-lbs. The formulation with masterbatch-C had an impact value of about 65 inch-lbs. The lower impact value of the formulation with masterbatch-A could be a result of one or more of the following: it had the highest extruder pressure; it had the lowest torque reading; it had the highest amount of added CaCO₃; and it had the highest amount (10%) of process aid, which has a very high melt viscosity. One or more of these factors could have led to poor homogenization of the melt resulting in a lower impact value.

Both the color and gloss of the extruded sheets were approximately the same for all extruded sheets, as shown in Table A8.

### Example Set B—Analysis of Polymer Compositions

The control formulation in Table B1 is that same as that found in A3 in Example Set A. Fusion time is measured as described in Example Set A (e.g., see Tables A4 and A5).

TABLE B1
PVC Control Formulation

| | PVC substrate | |
|---|---|---|
| | formulation only (control) | |
| | PHR | wt % |
| PVC Resin | 100.00 | 77.28 |
| Stabilizer | 1.00 | 0.77 |
| Process Aid | 1.00 | 0.77 |
| Impact Modifier | 4.00 | 3.09 |
| Calcium | 1.50 | 1.16 |
| Stearate | | |
| Paraffin Wax | 0.80 | 0.62 |
| Oxidized | 0.10 | 0.08 |
| Polyethylene | | |
| CaCO₃—A | 20.00 | 15.46 |
| TiO₂ | 1.00 | 0.77 |
| Totals | 129.40 | 100.00 |
| Total CaCO3 | 20.00 | 15.46 |

Table B1 provides the ingredients of the control formulation.

The masterbatches used in samples B3-B8 in used in Table were prepared using a Leistritz twin screw extruder. These masterbatches and other ingredients (i.e., per samples B1, B2, and B9-B11) were post added to the siding substrate control formulation according to the amounts shown in Table B2 and B5. The materials were hand mixed in the lab to assure complete dispersion. using a Leistritz twin screw extruder.

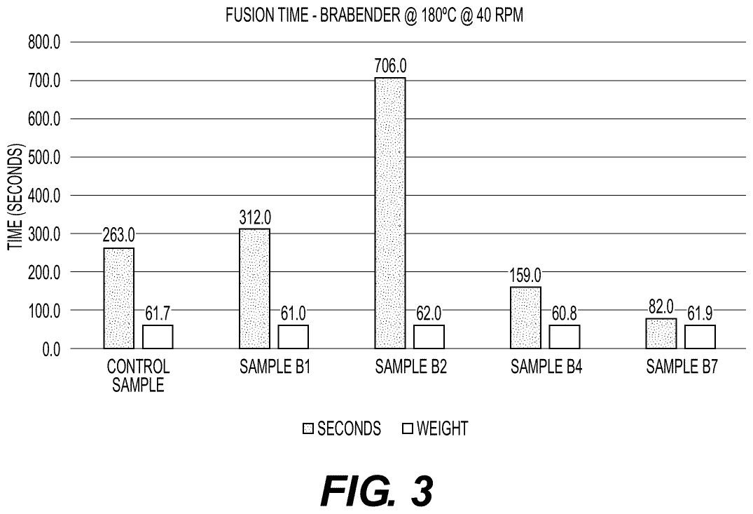

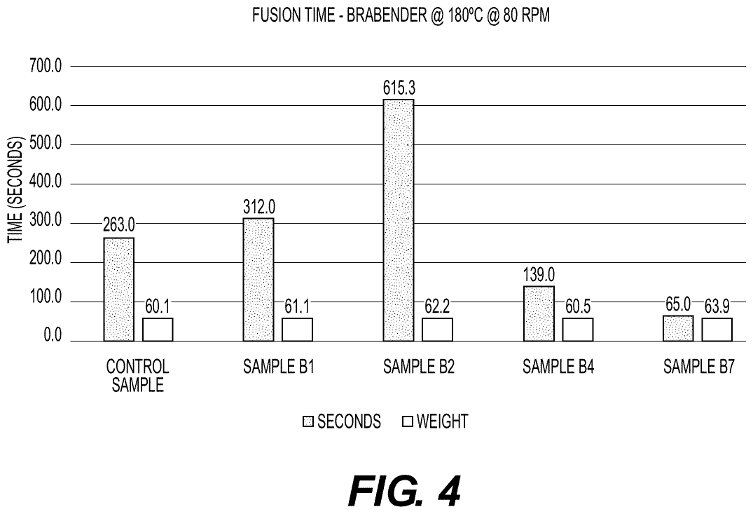

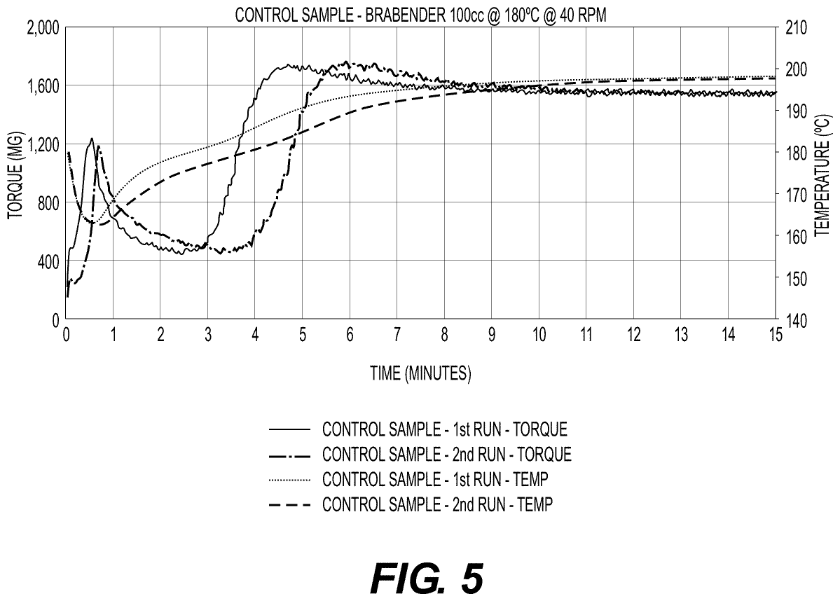

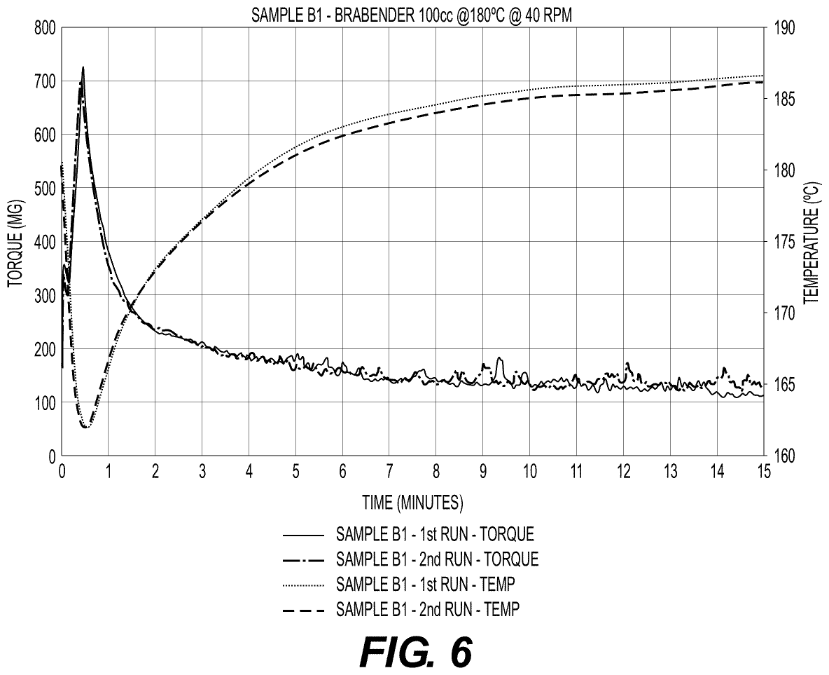

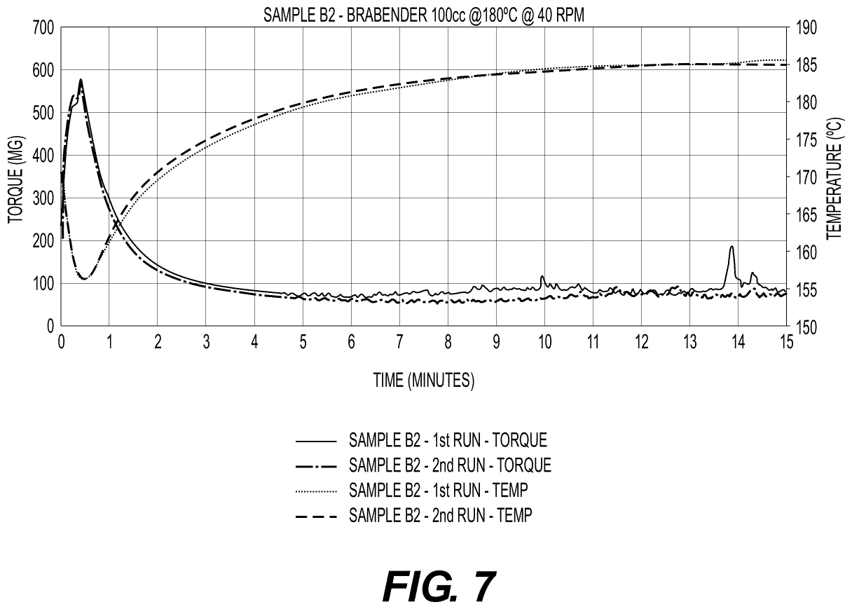

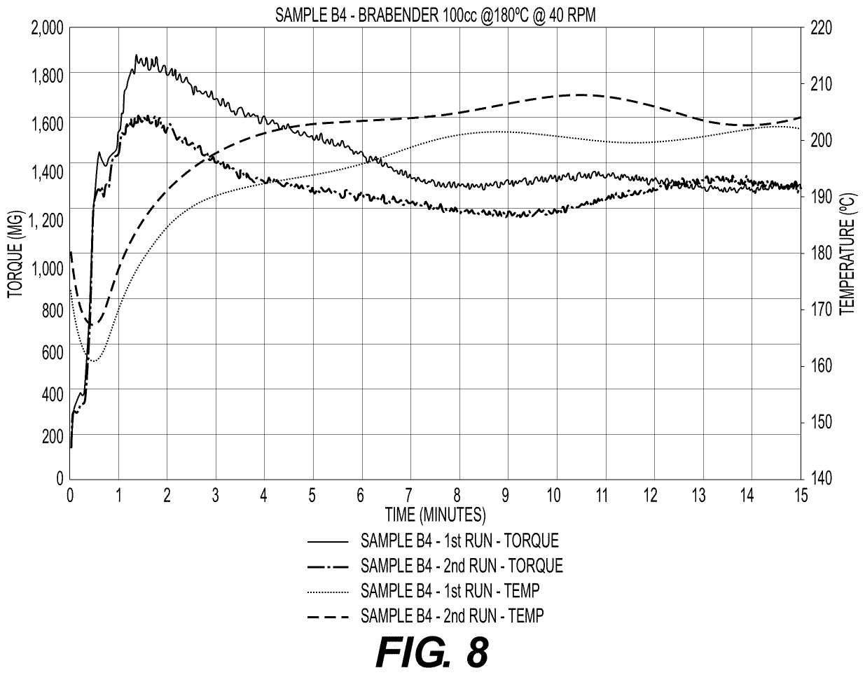

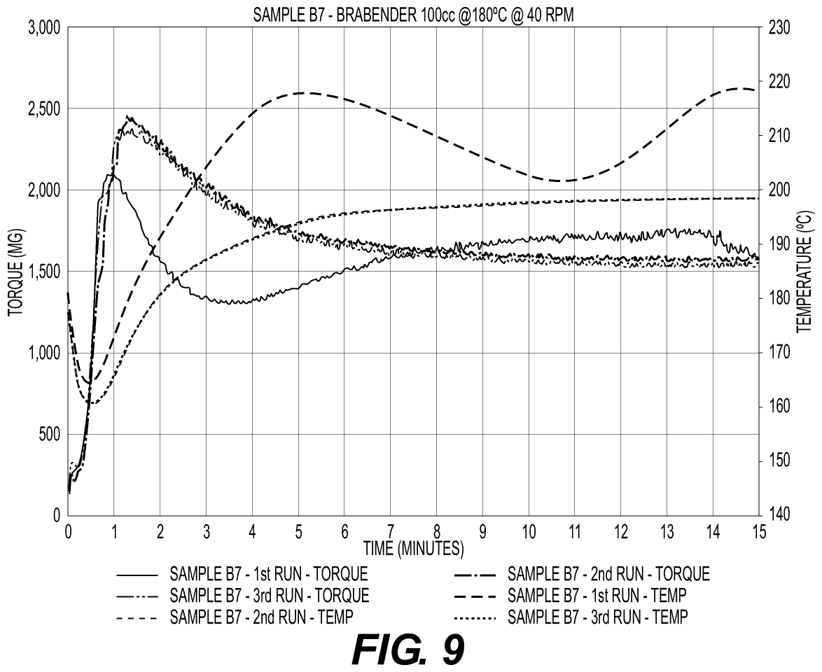

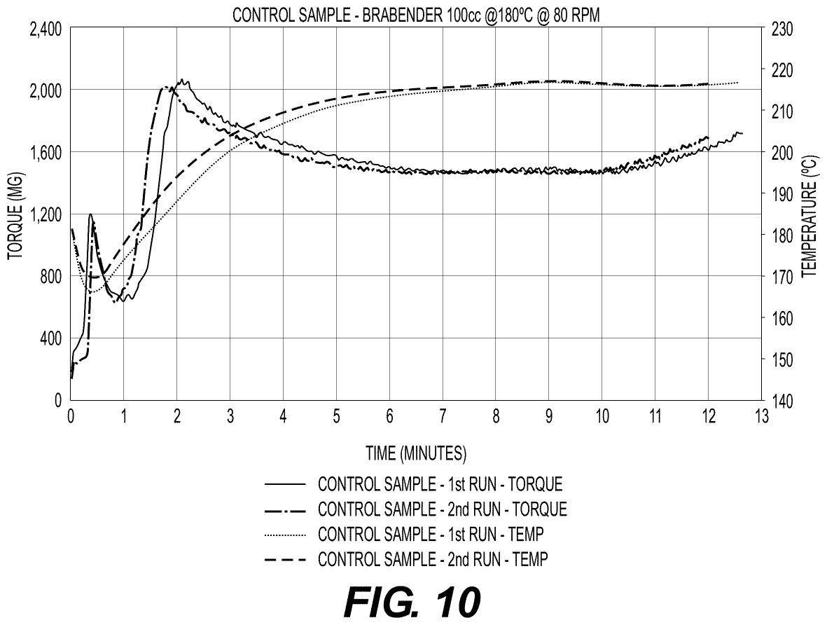

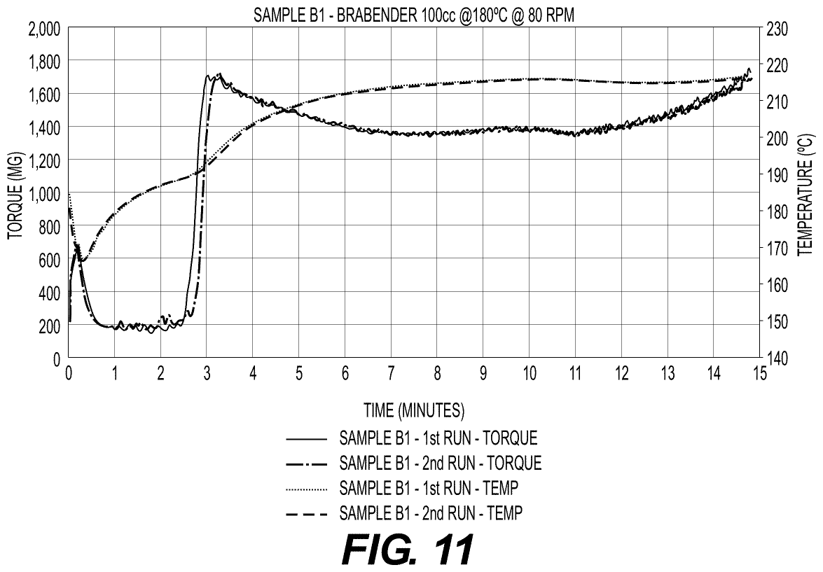

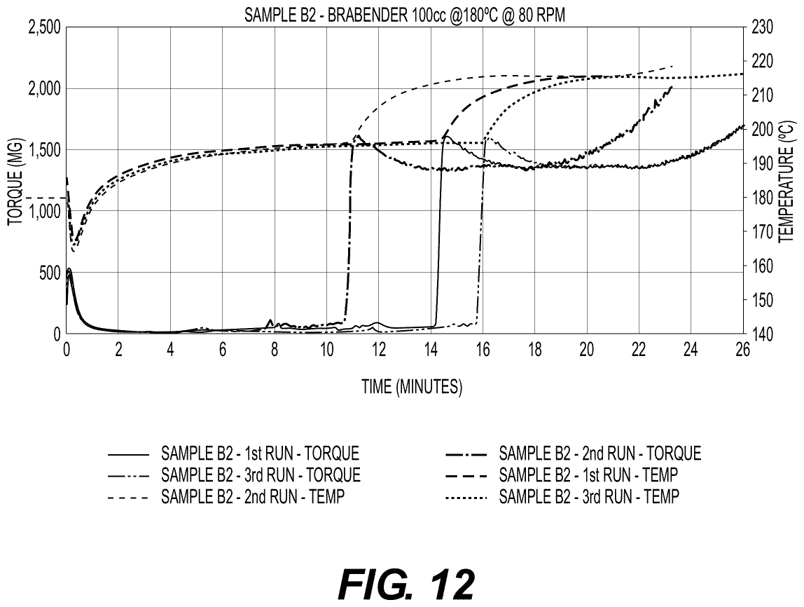

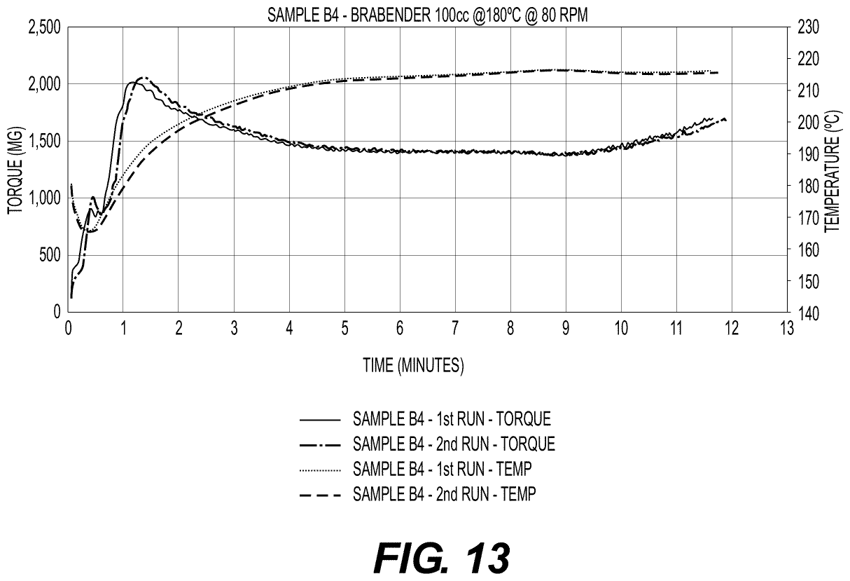

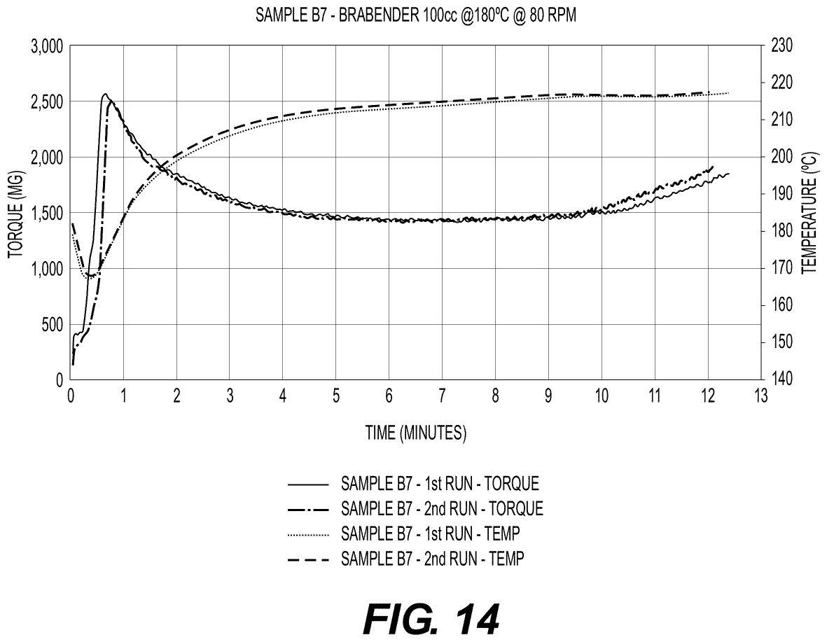

Representative melt rheology curves are provided in FIGS. 5-14. Fusion times are shown in FIGS. 3-4 and Tables B3, B4, and B6; these fusion times are averages of multiple determinations (+/−10%).

TABLE B2
Sample Formulations-Control plus added masterbatch with CaCO₃

| | Ingredients | | | | | | | |
|---|---|---|---|---|---|---|---|---|
| | PVC | | | | | | | |
| | Control | | | | | | | |
| | from | | | | Hi- | | | |
| | Table | CaCO₃- | | HM10 ® | Cal ™ | Total | Total | Total |
| | B1 | Bª | Minacoat ™ | HD^{c} | LM^{d} | PHR of | weight | CaCO₃ |
| Sample | (gms) | (gms) | E3^{b} (gms) | (gms) | (gms) | CaCO₃ | (gms) | wt % |
| Control | 200.00 | 0.00 | 0.00 | 0.00 | 0.00 | 20.0 | 200.00 | 15.46 |
| B1 | 200.00 | 7.80 | 0.00 | 0.00 | 0.00 | 25.0 | 207.80 | 18.59 |
| B2 | 200.00 | 15.60 | 0.00 | 0.00 | 0.00 | 30.0 | 215.60 | 21.51 |
| B3 | 200.00 | 0.00 | 10.40 | 0.00 | 0.00 | 25.0 | 210.40 | 18.59 |
| B4 | 200.00 | 0.00 | 0.00 | 10.40 | 0.00 | 25.0 | 210.40 | 18.59 |
| B5 | 200.00 | 0.00 | 0.00 | 0.00 | 10.40 | 25.0 | 210.40 | 18.59 |
| B6 | 200.00 | 0.00 | 20.80 | 0.00 | 0.00 | 30.0 | 220.80 | 21.51 |
| B7 | 200.00 | 0.00 | 0.00 | 20.80 | 0.00 | 30.0 | 220.80 | 21.51 |
| B8 | 200.00 | 0.00 | 0.00 | 0.00 | 20.80 | 30.0 | 220.80 | 21.51 |

^{a}CaCO₃-B obtained from Omya International AG; a high purity, ultrafine, wet ground, surface-treated natural calcium carbonate available in dry form with a d₅₀ of 0.7 μm, with a d₉₈ of 4.0 μm and a specific surface area BET (ISO 9277) of 9.5 m²/g; it is surface-treated with stearic acid.
^{b}Minacoat ™E3 was obtained from Heritage Plastics (Picayune, MS USA) and is a pelletized concentrate containing calcium carbonate in an autoclave-process low-density polyethylene carrier resin; it typically has a melt index (190° C., 2.16 kg-ASTM D1238) of 2.5 g/10 min., a density (ASTM D792) of 1.84 g/cc, and 76.5% Calcium Carbonate (ASTM D5630)
^{c}HM10 ®HD was obtained from Heritage Plastics (Picayune, MS USA) and is a high purity, fine particle size calcium carbonate (1 micron) in a HDPE carrier; it typically has a melt index (190° C., 2.16 kg-ASTM D1238) of 0.50 g/10 min., a density (ASTM D792) of 1.97 g/cc, and 81% Calcium Carbonate (ASTM D5630)
^{d}Hi-Cal ™LM was obtained from Heritage Plastics (Picayune, MS USA) and is a high purity, fine particle size calcium carbonate (1 micron) in a polypropylene homopolymer carrier; it typically has a melt flow rate (190° C., 2.16 kg-ASTM D1238) of 4.0 g/10 min., a density (ASTM D792) of 1.92 g/cc, and 80% Calcium Carbonate (ASTM D5630)

TABLE B3
Fusion Time Comparisons With Added CaCO₃
(Brabender @ 180° C. @ 40 RPM with 100 cc)

| | Total CaCO₃ | Total | Fusion time |
|---|---|---|---|
| Sample | in sample (PHR) | CaCO₃ wt % | (Seconds) |
| Control | 20.0 | 15.46 | 263.0 |
| B1 | 25.0 | 18.59 | 312.0 |
| B2 | 30.0 | 21.51 | 706.0 |
| B3 | 25.0 | 18.37 | 161.0 |
| B4 | 25.0 | 18.37 | 159.0 |
| B5 | 25.0 | 18.37 | 245.0 |
| B6 | 30.0 | 21.00 | 50.0 |
| B7 | 30.0 | 21.00 | 82.0 |
| B8 | 30.0 | 21.00 | 125.0 |

TABLE B4
Fusion Time Comparisons With Added CaCO₃
(Brabender @ 180° C. @ 80 RPM with 100 cc)

| | Total CaCO₃ | Total | Fusion time |
|---|---|---|---|
| Sample | in sample (PHR) | CaCO₃ wt % | (Seconds) |
| Control | 20.0 | 15.46 | 149.0 |
| B1 | 25.0 | 18.59 | 280.0 |
| B2 | 30.0 | 21.51 | 615.0 |
| B3 | 25.0 | 18.37 | 115.0 |
| B4 | 25.0 | 18.37 | 139.0 |
| B5 | 25.0 | 18.37 | 164.0 |
| B6 | 30.0 | 21.00 | 83.0 |
| B7 | 30.0 | 21.00 | 65.0 |
| B8 | 30.0 | 21.00 | 98.0 |

TABLE B5
Sample Formulations-Control and No Added CaCO₃

| | Ingredients | | | | | | |
|---|---|---|---|---|---|---|---|
| | PVC Control | | | | | | |
| | Formulation | LLDPE | | | Total | Total | Total |
| | from Table | copolymerª | HDPE^{b} | PP^{c} | PHR of | weight | CaCO₃ |
| Sample | B1 (gms) | (gms) | (gms) | (gms) | CaCO₃ | (gms) | wt % |
| Control | 200.00 | 0.00 | 0.00 | 0.00 | 20.0 | 200.00 | 15.46 |
| B9 | 200.00 | 1.0 | 0.00 | 0.00 | 20.0 | 201.00 | 15.46 |
| B10 | 200.00 | 0.00 | 1.0 | 0.00 | 20.0 | 201.00 | 15.46 |
| B11 | 200.00 | 0.00 | 0.00 | 1.0 | 20.0 | 201.00 | 15.46 |

^{a}the LLDPE copolymer is a butene copolymer LLDPE obtained from NOVA Chemicals (Moon Township, PA) as product NOVAPOL ® PI-2024-A Resin; it typically has a melt index (190° C., 2.16 kg-ASTM D1238) of 20 g/10 min. and a density (ASTM D792) of 0.924 g/cc.
^{b}the HDPE is a homopolymer high density polyethylene obtained from KW Plastics (Troy, AL) as product KWR101-150; it typically has a melt flow (ASTM D1238) of 0.6 g/10 min. and a density (ASTM D792) of 0.960 g/cc.
^{c}the PP is a a homopolymer polypropylene obtained from Braskem (Philadelphia, PA) as product FT200WV; it typically has a melt flow of (230° C., 2.16 kg-ASTM D1238) of 20 g/10 min.

TABLE B6
Fusion Time Comparisons Without Added CaCO₃
(Brabender @ 190° C. @ 80 RPM with 100 cc)

| | Total CaCO₃ in | Total | Fusion time |
|---|---|---|---|
| Sample | sample (PHR) | CaCO₃ wt % | (Seconds) |
| Control | 20.0 | 15.46 | 149.0 |
| B9 | 20.0 | 15.46 | 10 |
| B10 | 20.0 | 15.46 | 26 |
| B11 | 20.0 | 15.46 | 36 |

### Results and Discussion

The fusions time of the CaCO₃-only masterbatch addition to the control resulted in increases in fusion time as the amount of added CaCO₃ increased. When only polyethylene or only polypropylene were also added, fusion times decreased compared to control composition with the CaCO₃-only masterbatch addition or compared to the control composition without any addition.

The headings used in the disclosure are not meant to suggest that all disclosure relating to the heading is found within the section that starts with that heading. Disclosure for any subject may be found throughout the specification.

It is noted that terms like “preferably,” “commonly,” and “typically” are not used herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

As used in the disclosure, “a” or “an” means one or more than one, unless otherwise specified. As used in the claims, when used in conjunction with the word “comprising” the words “a” or “an” means one or more than one, unless otherwise specified. As used in the disclosure or claims, “another” means at least a second or more, unless otherwise specified. As used in the disclosure, the phrases “such as”, “for example”, and “e.g.” mean “for example, but not limited to” in that the list following the term (“such as”, “for example”, or “e.g.”) provides some examples but the list is not necessarily a fully inclusive list. The word “comprising” means that the items following the word “comprising” may include additional unrecited elements or steps; that is, “comprising” does not exclude additional unrecited steps or elements.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

Detailed descriptions of one or more embodiments are provided herein. It is to be understood, however, that the present invention may be embodied in various forms. Therefore, specific details disclosed herein (even if designated as preferred or advantageous) are not to be interpreted as limiting, but rather are to be used as an illustrative basis for the claims and as a representative basis for teaching one skilled in the art to employ the present invention in any appropriate manner. Indeed, various modifications of the invention in addition to those described herein will become apparent to those skilled in the art from the foregoing description and the accompanying figures. Such modifications are intended to fall within the scope of the appended claims.

What is claimed is:

1. A polymer composition comprising
a) a polymer resin composition comprising at least one halogenated polymer resin and a first calcium carbonate material, and
b) a masterbatch composition comprising (i) a second calcium carbonate material and (ii) at least one masterbatch polyethylene, at least one masterbatch polypropylene, or both; wherein
the at least one halogenated polymer resin is at least 50 wt % of the polymer composition,
the first calcium carbonate material is no more than 34 wt % of the polymer composition,
the second calcium carbonate material is from 1 to 35 wt % of the polymer composition,
the total calcium carbonate material in the polymer composition is from 17 to 35 wt % of the polymer composition,
and
the fusion time of the polymer composition is less than
(A) the fusion time of a composition consisting of (1) the polymer resin composition and (2) the second calcium carbonate material, or
(B) the fusion time of the polymer resin composition,
where the fusion time is measured according to ASTM D2538-18.

2. (canceled)

3. The polymer composition according to claim 1, wherein the calcium carbonate of the first calcium carbonate material, of the second calcium carbonate material, or both, has a weight median particle diameter d₅₀ of from 0.1 μm to 8.0 μm, more preferably from 1.3 μm to 1.5 μm and most preferably of 1.4 μm, measured according to the sedimentation method.

4. The polymer composition according to claim 1, wherein the calcium carbonate of the first calcium carbonate material, of the second calcium carbonate material, or both, has a specific surface area of from 1 m²/g to 25 m²/g, measured using the BET nitrogen method.

5-6. (canceled)

7. The polymer composition according claim 1, wherein the calcium carbonate of the first calcium carbonate material, of the second calcium carbonate material, or both, is ground calcium carbonate (GCC) and/or precipitated calcium carbonate (PCC).

8. The polymer composition according to claim 1, wherein at least 0.1%, of the aliphatic carboxylic acid accessible surface area of the calcium carbonate of the first calcium carbonate material, of the second calcium carbonate material, or both, is covered by a coating comprising (i) at least one aliphatic carboxylic acid having from 4 to 24 carbon atoms and/or reaction products thereof, (ii) at least one mono-substituted succinic anhydride, at least one mono-substituted succinic acid, at least one reaction product of mono-substituted succinic anhydride and/or at least one reaction product of mono-substituted succinic acid, or (iii) mixtures thereof.

9. (canceled)

10. The polymer composition according to claim 1, wherein the first calcium carbonate material, the second calcium carbonate material, or both, is present in an amount from 1 to 25 wt % of the polymer composition.

11. (canceled)

12. The polymer composition according to claim 1, wherein the total calcium carbonate material in the polymer composition is from 17 to 30 wt % of the polymer composition.

13. The polymer composition according to claim 1, wherein the at least one masterbatch polyethylene, at least one masterbatch polypropylene, or both are present in an amount from 0.1 to 5.0 wt % of the polymer composition.

14. The polymer composition according to claim 1, wherein the at least one masterbatch polyethylene has a density from 0.850 to 0.975 g/cm³.

19. (canceled)

20. The polymer composition according to claim 1, wherein the at least one halogenated polymer resin is selected from the group consisting of PVC, post-chlorinated vinyl polychloride (PVCC), polyvinylidene fluoride (PVDF), and mixtures thereof.

21. (canceled)

22. The polymer composition according to claim 1, wherein the at least one halogenated polymer resin is in an amount of from 50 to 90 wt % of the polymer composition.

23. The polymer composition according to claim 1, wherein the fusion time of the polymer composition is less than (A) the fusion time of a composition consisting of (1) the polymer resin composition and (2) the second calcium carbonate material or (B) the fusion time of the polymer resin composition, where the difference in fusion time is at least 1 second.

24. (canceled)

25. The polymer composition according to claim 1, wherein the fusion time of the polymer composition is less than the fusion time of a composition consisting of (1) the polymer resin composition and (2) the second calcium carbonate material.

26. (canceled)

27. The polymer composition according to claim 1, wherein the polymer composition is suitable to make a polymer product which has a density of below 1 g/cm³.

28. The polymer composition according to claim 1, wherein the polymer composition is suitable to make a polymer product which has an impact strength from 30 to 150 inch lbs, measured according to ASTM D4226.

29. (canceled)

30. A method for decreasing fusion time comprising
a) providing a polymer resin composition comprising at least one halogenated polymer resin and a first calcium carbonate material,
b) providing a masterbatch composition comprising (i) a second calcium carbonate material and (ii) at least one masterbatch polyethylene, at least one masterbatch polypropylene, or both, and
c) contacting the polymer resin composition with the masterbatch composition to provide a polymer composition;
wherein
the at least one halogenated polymer resin is at least 50 wt % of the polymer composition,
the first calcium carbonate material is no more than 34 wt % of the polymer composition,
the second calcium carbonate material is from 1 to 35 wt % of the polymer composition,
the total calcium carbonate material in the polymer composition is from 17 to 35 wt % of the polymer composition, and
the fusion time of the polymer composition is less than
(A) the fusion time of a composition consisting of (1) the polymer resin composition and (2) the second calcium carbonate material, or
(B) the fusion time of the polymer resin composition,
where the fusion time is measured according to ASTM D2538-18.

31-58. (canceled)

59. A polymer composition prepared according to claim 30.

60. A method for preparing a polymer product comprising the following steps:
(a) providing the polymer composition according to claim 1, and
(b) subjecting the polymer composition of step (a) to conditions under which the polymer composition is converted into a polymer product.

61. The method according to claim 60, wherein the polymer product has a density of below 1 g/cm³.

62. The method according to claim 60, wherein the polymer product has an impact strength from 30 to 150 inch lbs, preferably from 40 to 100 inch lbs, and measured according to ASTM D4226.

63. The method according to claim 60, wherein the polymer product has a Durometer Hardness of (a) at least 50 A, measured using ASTM D2240 with an A scale Durometer or (b) at least 20 D, measured using ASTM D2240 with a D scale Durometer.

64. A polymer product prepared according to claim 60.

65. A polymer product prepared from the polymer composition according to claim 1.

66. The polymer product of claim 64, wherein the polymer product is a pipe, tubing, siding, window profile, roller-blind profile, sheet, sign, tile, fencing, decking, gutters, credit card stock, blister pack, UL conduit, foam board, foam trim, ceiling tile, and vinyl record.

67. (canceled)
